(19) United States
(12) Patent Application Publication
(10) Pub. No.: US 2026/0343590 A1
(43) Pub. Date: Oct. 29, 2026

(54) STABLE QUALITY OF SERVICE (QOS)/QUALITY OF EXPERIENCE (QOE)

(71) Applicant: InterDigital Patent Holdings, Inc., Wilmington, DE (US)

(72) Inventors: Jaya Rao, Montreal (CA); Tejaswinee Lutchoomun, Montreal (CA)

(73) Assignee: InterDigital Patent Holdings, Inc., Wilmington, DE (US)

(21) Appl. No.: 19/117,283

(22) PCT Filed: Nov. 2, 2023
(86) PCT No.: PCT/US2023/078446

§ 371 Date: Mar. 31, 2025

Related U.S. Application Data
(60) Provisional application No. 63/421,686, filed on Nov. 2, 2022.

(51) Int. Cl. H04W 72/566; H04W 72/12

(52) U.S. Cl. CPC H04W 72/566; H04W 72/12

(57) ABSTRACT

A wireless transmit receive unit (WTRU) may be configured to receive configuration information comprising a threshold value. The WTRU may receive a first grant. The WTRU may determine to prioritize one or more protocol data units (PDUs) of a second PDU set over one or more PDUs of a first PDU set, in a transmission to be sent in accordance with the first grant, based on a remaining delay budget of the second PDU set being less than a remaining delay budget of the first PDU set or based on the remaining delay budget of the second PDU set being less than the threshold value. The WTRU may send the transmission comprising at least one of the one or more PDUs of the second PDU set in accordance with the first grant. The transmission may comprise information indicating that the second PDU set is prioritized over the first PDU set.

### CROSS REFERENCE TO RELATED APPLICATIONS

This application claims the benefit of U.S. Provisional Application No. 63/421,686 filed Nov. 2, 2022, the entire contents of which are herein incorporated by reference in their entirety.

### BACKGROUND

eXtended Reality (XR) may be used to refer to one or more different types of immersive experiences including Virtual Reality (VR), Augmented Reality (AR) and Mixed Reality (MR) and the realities interpolated among them. Virtual Reality (VR) may include a rendered version of a delivered visual and audio scene. The rendering may be designed to mimic the visual (e.g., stereoscopic 3D) and audio sensory stimuli of the real world as naturally as possible to an observer or user as they move within the limits defined by the application. Augmented Reality (AR) may be used to refer to when a user is provided with additional information or artificially generated items or content overlaid upon their current environment. Mixed Reality (MR) may include an advanced form of AR, e.g., where some virtual elements are inserted into the physical scene with the intent to provide the illusion that these elements are part of the real scene. XR may include the (e.g., all) real-and-virtual combined environments and human-machine interactions generated by computer technology and wearables.

### SUMMARY

A wireless transmit receive unit (WTRU) may be configured to receive configuration information comprising a threshold value. The WTRU may receive a first grant. The WTRU may determine to prioritize one or more protocol data units (PDUs) of a second PDU set over one or more PDUs of a first PDU set in a transmission to be sent in accordance with the first grant. The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value. The WTRU may send the transmission comprising at least one of the one or more PDUs of the second PDU set in accordance with the first grant. The transmission may comprise information indicating that the second PDU set is prioritized over the first PDU set.

The first grant may be a first dynamic grant or a first configured grant. The information indicating that the second PDU set is prioritized over the first PDU set may be transmitted in an Uplink Control Information (UCI) indication. The UCI indication may comprise information indicating remaining PDUs of the first PDU set and a remaining time associated with the first PDU set and information indicating remaining PDUs of the second PDU set and a remaining time associated with the second PDU set.

The information indicating that the second PDU set is prioritized over the first PDU set may be transmitted in a scheduling request (SR), a buffer status report (BSR), or a delay status report (DSR). The WTRU may receive a second grant. The one or more PDUs of the first PDU set may be received prior to the one or more PDUs of the second PDU set being received from the application layer.

Resources used for the transmission indicated by the first grant may be sufficient for including each of the one or more PDUs of the second PDU set. The transmission may comprise at least one PDU of the one or more PDUs of the first PDU set. The information indicating that the second PDU set is prioritized over the first PDU set may comprise an indication regarding at least one PDU of the first PDU set that was not included in the transmission.

Resources used for the transmission indicated by the first grant may be insufficient for including each of the one or more PDUs of the second PDU set. The indication that the second PDU set is prioritized over the first PDU set may comprise an indication regarding at least one PDU of the second PDU set that was not included in the transmission.

The one or more PDUs of the first PDU set may be mapped to a first logical channel (LCH) and the one or more PDUs of the second PDU set may be mapped to a second LCH. The one or more PDUs of the first PDU set and the one or more PDUs of the second PDU set may be mapped to the first LCH. The first PDU set may be associated with a first priority and a first payload size. The second PDU set may be associated with a second priority and a second payload size. The indication may comprise the first payload size and/or the second payload size.

A wireless transmit receive unit (WTRU) may be configured to receive configuration information comprising an indication of a first control channel monitoring configuration, a second control channel monitoring configuration, and a threshold value. The WTRU may monitor for control channel transmissions in accordance with the first control channel monitoring configuration. The WTRU may receive a first set of one or more protocol data unit (PDUs) based on a first control channel transmission received in accordance with the first control channel monitoring configuration. The WTRU may determine that at least one PDU of the first set of one or more PDUs remained in an application buffer for a period of time that is greater than the threshold value, or a remaining delay budget associated with the first set of one or more PDUs is less than a threshold. The WTRU may monitor for control channel transmissions in accordance with the second control channel monitoring configuration based on determining that the at least one PDU of the first set of one or more PDUs remained in the application buffer for the period of time that is greater than the threshold value, or the remaining delay budget associated with the first set of one or more PDUs is less than the threshold. The WTRU may transmit an indication that the WTRU has switched to the second control channel monitoring pattern.

The first control channel monitoring configuration may comprise a first search space and the second control channel monitoring configuration may comprise a second search space. The WTRU may receive a second set of one or more PDUs based on a second control channel transmission received in accordance with the second control channel monitoring configuration. The second set of one or more PDUs may be associated with the first set of one or more PDUs. The association may be determined based on a common identifier. The WTRU may decrease a periodicity of monitoring based on the at least one PDU of the first set of one or more PDUs remaining in the application buffer for the period of time that is greater than the threshold value. The WTRU may receive the first set of one or more PDUs in a transmission.

The WTRU may update, based on the threshold value, a periodicity of monitoring and a reporting of an application buffer depletion rate, wherein the application buffer depletion rate is associated with an amount of PDUs of the first set of one or more PDUs remaining in the application buffer and a period of time that the PDUs of the first set of one or more PDUs has remained in the application buffer.

The WTRU may transmit the indication when updating a reporting periodicity. The WTRU may report, in a separate transmission, one or more statistics regarding the period of time that the at least one PDU of the first set of one or more PDUs remained in the application buffer.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example associated with interactive and/or split rendering applications.

FIGS. 3A-3F illustrate examples associated with mapping XR data units during UL transmission.

FIGS. 4A-4C illustrate examples associated with mapping physical data unit (PDU) sets with logical channels.

FIG. 5 illustrates transmissions of PDU sets according to embodiments.

FIG. 6 illustrates a flowchart associated with receiving PDU sets according to several embodiments.

### DETAILED DESCRIPTION

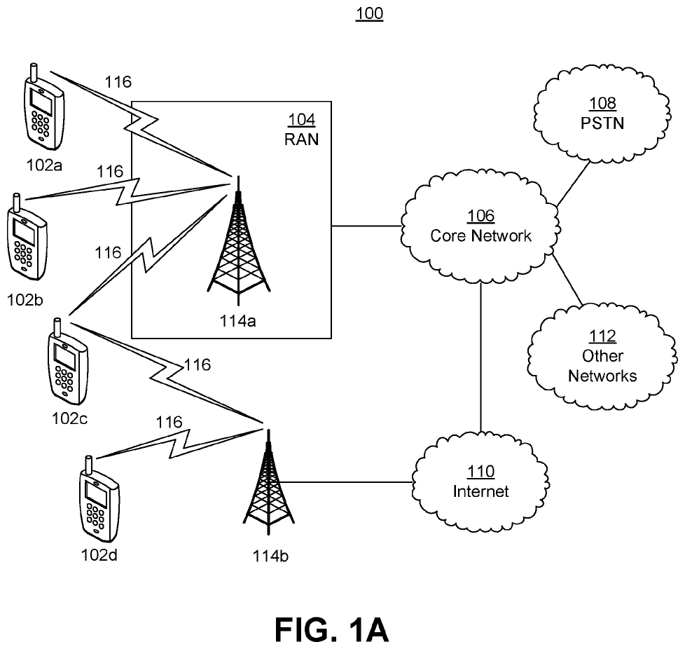

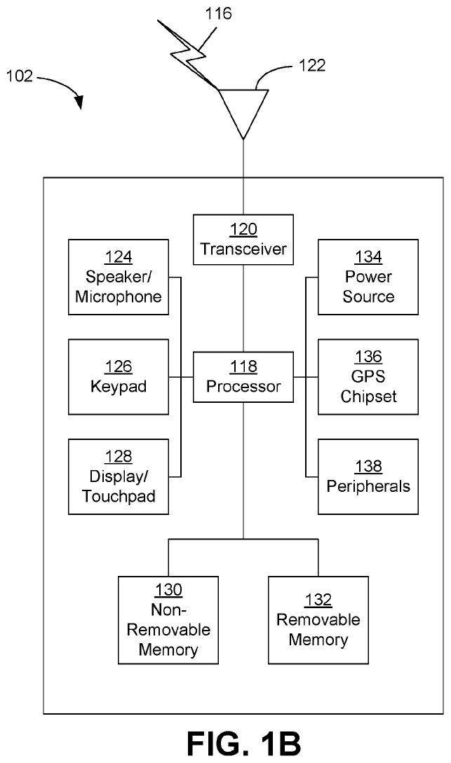

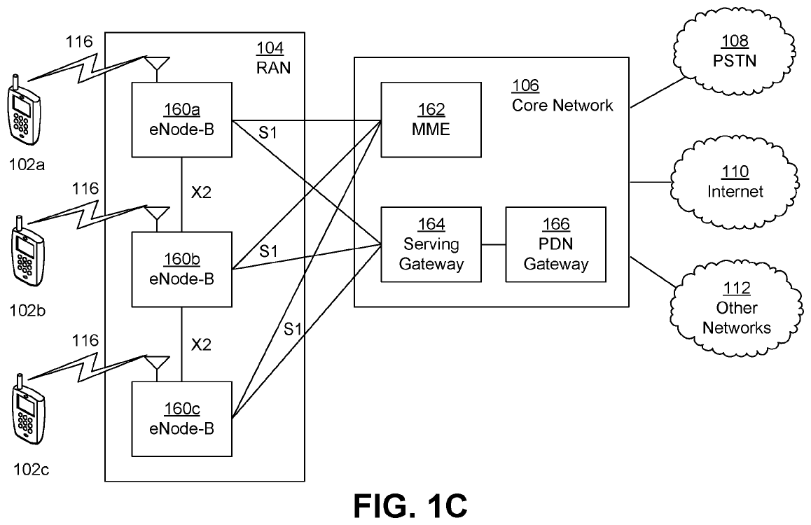

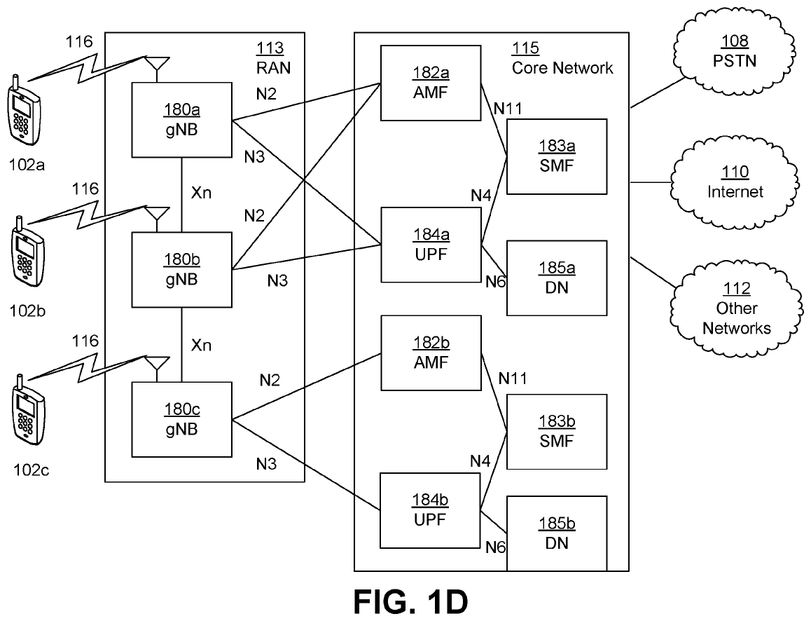

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel.

The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The notion of immersion in the context of XR applications/services may refer to the sense of being surrounded by a virtual environment as well as providing the feeling of being physically and spatially located in the virtual environment. The levels of virtuality may range from partial sensory inputs to fully immersive multi-sensory inputs, which may lead to a virtual reality practically indiscernible from actual reality.

XR devices may be associated with capabilities that offer various degrees of spatial tracking. XR devices may be equipped with various sensors to enable spatial tracking. For example, XR devices may be equipped with monocular/stereo/depth cameras, radio beacons, GPS, inertial sensors etc. Such spatial tracking may be performed at different levels, including, e.g., 3 Degrees of Freedom (DoF) (e.g., rotational motion along X, Y and Z axis), 6 DoF (e.g., rotational and/or translational motion along X, Y and Z axis).

Such spatial tracking may result in an interaction to experience some form of virtual content. The user may act in and/or interact with the components within extended reality. For example, the user actions and/or interactions may involve movements, gestures, eye tracking etc. Spatial tracking may be used to enable an immersive XR experience. Head and/or motion tracking may be used to simulate one or more visual and/or audio components from the user's perspective. Also, or alternatively, the visual and/or audio components may be updated according to the user's movements. Imprecise and/or delayed spatial tracking may lead to a sensation of discomfort and/or motion sickness for the user.

As described herein, a WTRU may correspond to an (e.g., any) XR device/node, which may come in variety of form factors. A WTRU (e.g., XR WTRU) may include: Head Mounted Displays (HMD), optical see-through glasses and camera see-through HMDs for AR and MR, mobile devices with positional tracking and camera, wearables, haptic gloves, haptic body suit, haptic shoes, etc. In addition to the above, several different types of XR WTRUs may be envisioned based on XR device functions, including, e.g., as display, camera, sensors, sensor processing, wireless connectivity, XR/Media processing, and power supply, to be provided by one or more devices, wearables, actuators, controllers and/or accessories. One or more device/nodes/WTRUs may be grouped into a collaborative XR group for supporting any XR applications/experience/services.

In XR services and applications such as AR, VR, and Cloud Gaming the traffic may include data/PDUs that may be associated with an application data Unit (ADU), a PDU set, and/or a data burst. For example, the PDUs belonging to a PDU set may be associated with different segments and/or components of a video frame and/or a video slice. A data burst may include one or more PDU sets. The number of PDUs in a PDU set and/or data burst of a total payload size (e.g., units of bits/bytes) transmitted in UL and/or received in DL may be dependent on the type of the media frame (e.g., 3D video frame, audio frame, etc.).

In certain XR applications (e.g., interactive and split rendering), a WTRU may transmit XR traffic that may comprise one or more PDUs/PDU sets in one or more data bursts in the UL (e.g., pose, gesture, video data). The WTRU may also, or alternatively, receive XR traffic in the DL (e.g., video, audio, haptics). Such traffic may be transmitted and/or received periodically and/or aperiodically in one or more data flows (e.g., QoS flows). During UL transmissions, for example XR traffic may arrive from an application layer at the WTRU at different time instances and/or with different traffic attributes (e.g., variable payload sizes). To abide by the QoS constraints (e.g., PDU set delay bound (PSDB) and/or if a PDU set error rate (PSER)) is to be met, the WTRU may be configured to report (e.g., on a timely basis) the information regarding the XR traffic (e.g., timing/delay info and/or payload info of PDU sets) to the network (e.g., base station) such that scheduling and/or resource allocation may be performed efficiently. Similarly, in the DL the network (e.g., base station) may not be aware of whether/how the XR traffic is consumed by the application in the WTRU. The data delivered in the DL within the QoS may end up being buffered for a long duration and/or discarded (e.g., by the WTRU) due to delays associated with rendering at the application. Such information, when reported by the WTRU to the network (e.g., base station) may be useful for deciding on how to schedule the data in DL.

In XR traffic, the different PDUs and/or PDU sets in a data burst may contribute to different user experiences (e.g., Quality of Experience (QoE). The PDUs/PDU sets may be associated with different importance/priority values from application layer perspective (e.g., spatial and/or temporal importance when rendering and displaying the media). One or more PDU sets transmitted sequentially in time domain may be inter-dependent with each other. In certain QoS frameworks, the (e.g., all) PDUs/PDU sets in a flow may be provided with the same forwarding treatment (e.g., by assuming equal importance/priority).

In certain QoS frameworks (e.g., XR), the PDUs/PDU sets in a data burst for traffic may be differentiated based on the respective QoS associated with the traffic, irrespective of whether the PDUs/PDU sets are in one or more flows, during scheduling and transmissions in UL and/or DL. In The inter-dependencies between the PDUs/PDU sets in a single and/or multiple QOS flows may result in different challenges for meeting the QoS at the PDU set level (e.g., PDU set delay bound (PSDB), PDU set error rate (PSER)) during transmission in UL and DL. The PDU sets and/or data bursts received from higher layers in a WTRU may not be mapped (e.g., efficiently mapped) to one or more configured DRBs/LCHs such that suitable ordering of the data units and forwarding treatment for QoS is provided during UL transmissions. Also, the ability for PDUs and/or PDU sets to be discarded when previously transmitted data units are not successfully delivered within the QoS (e.g., based on the knowledge of inter-dependencies between the data units) may not be known.

As such, certain techniques may be used to stabilize the QoS/QoE when there are variations in the XR traffic attributes in UL and/or DL. One or more of the following may apply. XR traffic related measurements may be reported to the network (e.g., base station), e.g., on a timely basis during scheduling and data transmissions in UL and/or DL. The XR traffic (e.g., PDU sets, data bursts) received from higher layers at the WTRU may be mapped to one or more DRBs/LCHs (e.g., such that ordered transmission of data units and QoS constraints are met).

A WTRU may trigger scheduling request (SR)/buffer status report (BSR), e.g., based on the triggering conditions associated with XR data units. A WTRU may determine to trigger an indication (e.g., SR/BSR) based on the arrival time of the XR data unit (e.g., PDU set, data burst) and/or the priority associated with the data unit. The WTRU may be configured to receive configuration information. The configuration information may include: one or more configurations and/or parameters associated LCHs; and/or one or more delay threshold values (e.g., difference between the time of arrival of a PDU set (e.g., time slot) and the PSDB associated with the PDU set). The WTRU may receive one or more PDU sets from higher layers/application.

The WTRU may map the data units to one or more LCHs, e.g., based on the priority of the data units. If any of the LCHs are empty (e.g., no buffered data) and/or if the priority of the PDU set is higher than the priority of any remaining PDU sets received previously in any of the LCHs, the WTRU may transmit an indication of the payload size of the PDU set to the network. If the priority of a first PDU set is lower than of the priority of the remaining PDU sets received previously (e.g., in any of the LCHs) and/or if the difference between the time of arrival of the PDU set into the LCH and the PSDB of the PDU set is greater than a delay threshold, the WTRU may transmit an indication of the payload size of the PDU set to the network. The WTRU may transmit the data units in the UL, e.g., using the resources allocated by the network.

As described herein, the network may include any of: a base station (e.g., gNB, TRP, RAN node, access node), a core network function (e.g., AMF, SMF, PCF, NEF), and/or an application function (e.g., edge server function, remote server function).

As described herein, flows may correspond to any of: a QoS flows and/or data flows (e.g., flow of data that may comprise one or more PDUs, PDU sets and/or data bursts, which may be associated with one or more QoS requirements, e.g., latency, data rate, reliability, RTT latency). As described herein, different flows (e.g., originating from a common application/experience source and/or intended to a common destination device/WTRU and/or group of associated devices/WTRU) may be referred to associated flows and/or correlated flows.

As described herein, a data unit may refer to any of: one or more frames (e.g., media/video/audio frame and/or slice/segment), PDUs, PDU sets, data bursts, group of frames/PDUs/PDU-sets/data bursts, etc.

As described herein, QoE may correspond to any of: application and/or higher layer metrics and measurements, which may be directly and/or indirectly detectable/visible at the WTRU and/or application function. Such QoE metrics and measurements may and/or may not be directly visible/detectable at the base station. Such QoE metrics and measurements may be determined/performed as a function of QoS metrics/parameters (e.g., latency, data rate, reliability, RTT/MTP latency).

As described herein, forwarding configuration may correspond to any of the following: radio bearers (e.g., data radio bearers (DRBs) and/or signaling radio bearers (SRBs), logical channels (LCHs), logical channel groups (LCGs), configuration parameters in the individual layers within the AS protocol stack (e.g., SDAP, PDCP, RLC, MAC, PHY, etc.), parameters associated with logical channel prioritization (LCP) (e.g., priority, PBR, BSD), BWPs, carriers, radio links/interfaces (Uu links, SLs), and radio resources (e.g., set of one or more frequency/time/spatial resources such as symbols, slots, subcarriers, resource elements and/or beams). Radio resources may be associated with configurated grants (CG), dynamic grants (DG) and/or any other resource grants and/or grant free resources.

As described herein, a mapping configuration may include parameters and/or configurations associated with mapping. A mapping configuration may be used to map data units, PDUs, SDUs, PDU sets, data bursts, application data (e.g., ADU) flows, QOS flows (e.g., associated and/or non-associated) to one or more of: radio bearers (e.g., DRBs, SRBs), sublayers and/or entities (e.g., SDAP, new layer, PDCP, RLC, MAC, PHY), LCHs, carriers and/or component carriers (e.g., CCs in CA configurations), BWPs, and radio links/interfaces (e.g., Uu link and/or sidelinks). The data units, PDUs, SDUs, PDU sets, data bursts, application data (e.g., ADU) flows, QOS flows (e.g., associated and/or non-associated) may originate from any of application layer, higher layers, and/or network. Radio bearers (e.g., DRBs, SRBs), sublayers and/or entities (e.g., SDAP, new layer, PDCP, RLC, MAC, PHY), LCHs, carriers and/or component carriers (e.g., CCs in CA configurations), BWPs, and radio links/interfaces (e.g., Uu link and/or sidelinks) may be used for delivering the data/PDUs in UL direction and/or DL direction.

As described herein, XR/application-aware data transmissions/receptions and/or XR/application-aware QoS handling may correspond to the attributes associated with PDU set, ADU and/or data burst. A PDU set (e.g., media unit, video frame) may comprise one or more PDUs. A PDU set may be associated with PDU set-level QoS requirements (e.g., data rate, latency, error rate, reliability), which may be applicable for one or more of (e.g., all) PDUs associated with a PDU set. The different PDUs in a PDU set may be associated with individual PDU-level QoS requirements.

A data burst may refer to the data produced by the application in a short period of time. A data burst may comprise PDUs from one or more PDU sets. Such attributes, associations and/or inter-dependencies (e.g., intra-PDU set and/or inter-PDU set), including the start/end indication of a PDU set/data burst (e.g., via sequence number, start/end indication), start/end time, duration, payload sizes, periodicity, importance/priority and QoS (e.g., PSDB) may be visible to the AS-layers (e.g., with associated IDs) and/or handled at the AS layers (e.g., with the awareness of the association during data transmission in UL and reception in DL).

As described herein, XR/application-aware data transmissions/receptions and/or XR/application-aware QoS handling may correspond to application/high layer importance/priority. The different PDUs in a PDU set and/or all PDUs in a PDU set may be associated with different application/high layer importance/priority values. The importance/priority values may correspond to spatial importance (e.g., spatial position of the video frame whose data is carried by the PDU/PDU set, where PDUs/PDU set carrying field of view (FoV) spatial positions may be associated with higher spatial importance than non-FoV spatial positions) and/or temporal importance (e.g., time sequence of the video frame who data is carried by the PDU/PDU set, where PDUs/PDU sets carrying base video frames such as I-frame may be associated with higher temporal importance than differential video frames such as P-frame/B-frame). The importance/priority values may be visible to the AS layers (e.g., with associated IDs/markers/indications) and/or may be enabled by application awareness during data transmission and reception.

As described herein, XR/application-aware data transmissions/receptions and/or XR/application-aware QOS handling may correspond to a QoS/data flow. The PDUs/PDU sets of an application may be encoded and delivered by the application to WTRU (in UL) and/or network (in DL) via one or more QoS/data flows. The different QoS flows carrying the PDUs/PDU sets associated with an XR application/experience may be visible to the AS-layers (e.g., with associated IDs) and/or handled at the AS layers with the awareness of the association during data transmission and reception.

As described herein, WTRU actions (e.g., related to application actions and/or AS-layer actions for ensuring/supporting differentiated QOS) may correspond to determining metadata associated with an application (e.g., XR application). One or more of the following may apply. Determining metadata may include determining any of the FoV/visual/spatial perimeters, 2D/3D size, border, spatial attributes and boundaries of FoV. Metadata may be determined based on measurements in any spatial dimensions, including but not limited to longitude, latitude, altitude, depth, roll, pitch, yaw in one more coordinate systems (e.g., cartesian, spherical).

Determining metadata may involve determining the quality of the FoV content (e.g., whether the FoV content is of high quality (which in the case of an image, may be quantified and assessed by the image resolution (e.g., number of density of megapixels)). Determining metadata may include determining the importance and/or priority of the FoV content. The importance may be associated with the spatial importance and/or temporal importance of content/data. The spatial/temporal importance value may indicate the absolute and/or relative importance associated with the FoV content. Spatial importance may be associated with one or more segments/tiles/slices/positions of FoV in spatial dimension. Temporal importance may be associated with one or more frames/subframes of FoV in time dimension.

As described herein, WTRU actions (e.g., related to application actions and/or AS-layer actions for ensuring/supporting differentiated QoS) may correspond to determining/generation of application content. One or more of the following may apply. Determining application content may include determining/capturing the one or more 2D/3D images/video frames associated with an FoV boundary/perimeter/border (e.g., as defined by the FoV metadata by the WTRU/node for itself and/or on behalf of another WTRU/node). For FoV content mapping, the WTRU may determine the images/video frames using visual sensors (e.g., 2D/3D camera, lidar), RF sensors (e.g., RF transceiver, RADAR), audio sensors (e.g., sonar), etc. As described herein, the mapping of FoV may also be referred to as sensing of FoV content and/or capturing of FoV content. Determining application content may also, or alternatively, include recording/capturing of audio frames (e.g., either as part of the real environment and/or as part of an overlaid sound-track/audio file with the audio file originating from a source other than the current real environment being mapped).

As described herein, WTRU actions (e.g., related to application actions and/or AS-layer actions for ensuring/supporting differentiated QoS) may correspond to performing measurements and reporting. The WTRU may perform measurements associated with positioning/spatial/pose (e.g., 6DoD/3DOD orientation, location/position), rate of motion/movement, etc. of the user WTRU and/or other objects (e.g., virtual and/or real) that the user may be interacting with. The WTRU may send/report the pose measurements to network, periodically and/or when detecting event triggers (e.g., change in pose measurements above/below a threshold). The WTRU may perform measurements of one or more of reference signals and/or channels (e.g., SSB, CSI-SR, PRS, sidelink RS), GNSS signals, unlicensed carriers, ultra-wideband signals, LIDAR signals, visual signals, etc. The WTRU may perform measurements of the radio link interfaces associated with the WTRU (e.g., Uu link, SL). The WTRU may trigger transmission and/or measurement of reference signals in other WTRUs (e.g., via Uu link and/or sidelink). The WTRU may send measurement reports to the network and/or other WTRUs.

As described herein, WTRU actions (e.g., related to application actions and/or AS-layer actions for ensuring/supporting differentiated QoS) may correspond to handling/forwarding of data/PDUs/PDU sets and handling QOS associated with PDUs/PDU sets. Data may include any of media/image/video frames, sensor data, and measurement data (e.g., pose measurements, link/channel measurements) determined by WTRU (e.g., for supporting an application/service/network request associated with the WTRU). The WTRU may send and/or receive data to/from one more destinations including a RAN node (e.g., gNB), CN function/entity, application function (e.g., hosted in WTRU and/or in network). The WTRU may perform splitting/merging of data/PDUs in one or more QoS flows into one or more forwarding configurations during transmission/receptions.

As described herein, WTRU actions (e.g., related to application actions and/or AS-layer actions for ensuring/supporting differentiated QoS) may correspond to handling/forwarding of information related to connectivity with network and/or other WTRUs. The WTRU may send capability information to the network. The capability may include information for supporting one or more traffic flows with different XR traffic patterns (e.g., periodic/aperiodic, PDU sets with variable payload sizes), capability for performing application layer measurements (e.g., QoE measurements, application buffer measurements, RTT measurements), and/or capability for detecting changes to traffic patterns. The WTRU may send inter-WTRU coordination capability information to network. The inter-WTRU coordination capability information may include information for supporting one or more interfaces, and/or certain capabilities to coordinate and/or interact with other WTRUs/devices (e.g., via SL interfaces), which may be co-located and/or non co-located with the WTRU. The WTRU may receive a configuration, including receiving RRC configuration from gNB and/or NAS-layer configuration from the CN. The WTRU may send and/or receive assistance data to/from the network associated with traffic, QoS, scheduling, etc., for supporting UL/DL transmissions. The WTRU may send requests for radio resources and/or resource grants (e.g., dynamic grants, semi-static/configured grants). The WTRU may receive a first grant and/or a second grant. The WTRU may also receive configuration information comprising a threshold value. The WTRU may also receive a second grant.

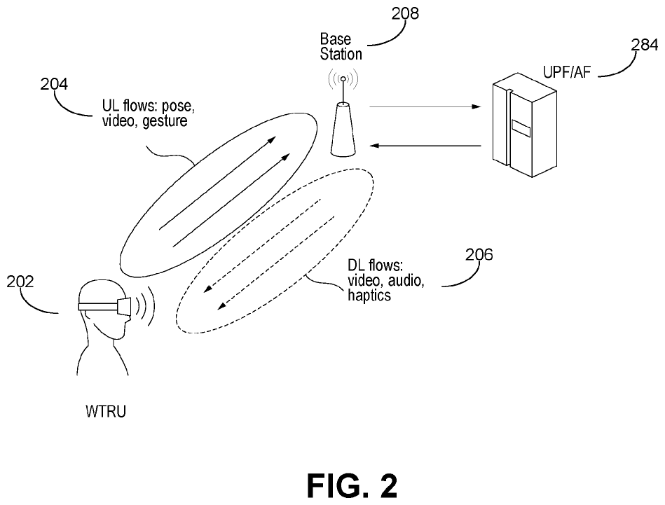

FIG. 2 illustrates an example associated with interactive and/or split rendering applications. As shown in FIG. 2, a WTRU 202 (e.g., headset) may transmit PDU sets in one or more flows in the UL 204 (e.g., pose, gesture, video data flows). The WTRU 202 may receive PDU sets in one or more flows in DL 206 (e.g., video, audio, haptics flows).

The UPF/application function (AF) AF 284 may perform functions such as routing, accessing NEF, and interaction with a policy framework for policy control. The UPF/AF may be an example of the UPF/AF 182a, b and 184a, b of FIG. 1D.

Described herein are techniques that may be used to stabilize the QoS/QoE when transmitting/receiving XR traffic.

The data units that include PDUs, PDU sets and/or data bursts associated with XR traffic received in one or more QoS flows (e.g., with the same and/or different QoS requirements/characteristics) may be mapped to one or more forwarding configurations using mapping configurations. The different forwarding configurations may be configured to achieve/enforce different QoS when transmitting the PDUs/PDU sets. In an example, the PDU sets received from application in one or more QoS flows may be mapped using a mapping configuration (e.g., via a service data adaptation protocol (SDAP)) to one or more forwarding configurations (e.g., DRBs with common/different PDCP entities). The forwarding configurations may be associated/grouped for achieving/ensuring PDU set level QoS. Upon mapping, the configuration (e.g., priority, PSDB) at the forwarding configurations for achieving/enforcing PDU set-level and/or data burst-level QOS may be applied to the PDUs/PDU sets (e.g., the PDUs/PDU sets in the buffers associated with the forwarding configuration).

The PDUs of different PDU sets and/or the PDU sets of a data burst received from application/higher layers may be associated with different QoS expectations during transmission. Based on the relevant QoS expectations for the PDUs/PDU sets received and/or to be received in QoS flows, a WTRU 202 may apply certain mapping, buffer/queue management, and adaptation mechanisms at one or more layers of the AS layer protocol stack (e.g., SDAP, PDCP, MAC) such that the expected QoS associated with the PDUs are satisfied and maintained during transmission and/or upon reception at network. A similar approach may be applied when the WTRU 202 expects to receive any of the PDU/PDU sets in DL 206 from the network. The application of mapping, buffer/queue management, and adaptation mechanisms at one or more layers of the AS layer protocol stack may be used to satisfy and/or maintain the respective QoS and/or achieve the QoE performance.

The layers (e.g., different layers) in a forwarding configuration may be configured with different configuration parameters (e.g., in order to satisfy and/or maintain the QoS of PDUs/PDU sets). Such configuration parameters may include support for AM/UM in RLC, LCP rules/restrictions and/or associated LCH parameters (e.g., PBR, BSD, priority) at MAC and number of HARQ transmissions. Certain parameters may be configured and/or adapted at the PDCP (e.g., sequence numbers (SN), sequence number size, ROCH) and the SDAP (e.g., mapping between QFI/PDU sets and DRBs) sublayers, which may be used to satisfy/maintain the QoS.

As described herein, QOS and/or QoS expectations may be used to denote the expected margin of a certain QoS metric (e.g., latency, data rate, reliability) before the arrival of the data that may comprise the respective PDUs, PDU sets, and/or data bursts and/or when the data is received at the WTRU 202 (e.g., the QoS to be achieved/enforced when transmitting). In some examples, the QoS expectations may be impacted by the QoE performance (e.g., achievable QoE performance). The QoS expectations may correspond to a time duration available at the WTRU 202 from the reception of the data (e.g., from higher layers) to the delivery (e.g., successful delivery) of the data over the radio link (e.g., Uu link and/or sidelink). The QoS expectations may also correspond to the time-to-live (TTL) (e.g., maximum time available for buffering, processing and delivering) for an individual PDU, PDU set, and/or data burst. The QoS expectations may be determined based on the indications/markers in the PDUs/PDU sets (e.g., QFI, timestamps, PDU set ID, etc., in the packet headers of the PDU/PDU sets). Also, and/or alternative, the QOS expectations may be determined based on usage timers, which may be set when receiving the PDUs/PDU sets and reset/stopped upon expiration of a configured time duration. Similar mechanisms (e.g., based on indications/markers and/or timers) may be applied for changing between different mapping and/or forwarding configurations for stabilizing/maintaining QOS expectations.

In some examples, the expected QoS may be stricter and/or more relaxed than a first (e.g., default) QOS metric associated with the PDUs/PDU sets. If a PDU set arrives late at the WTRU 202 and/or the importance value for the PDU set may be indicated to be high (e.g., above a threshold), the expected latency to be satisfied over the Uu link for the PDU set may be lower than a set PSDB (e.g., the default PSDB that is used for sending the PDUs of the PDU set). The PDU set (e.g., the PDU set that arrives late at the WTRU 202) may have experienced increased delay and/or jitter at the application layer (e.g., due to encoder), Also, or alternatively, if a PDU set arrives early and/or the importance value for the PDU may be indicated to be low (e.g., below a threshold), the expected latency over the Uu link may be considered to be more relaxed than the first PSDB (e.g., the PDSB that is normally used for sending such PDUs).

The expected QoS may vary (e.g., dynamically) based on the QoS experienced during reception and/or importance/priority indications. For a QOS that is fixed (e.g., fixed per PDB, PER, PSDB, PSER), an increase/decrease in the QoS prior to reception may translate to a decrease/increase in the QoS over the radio link (e.g., Uu link).

A WTRU may be configured to stabilize QoS/QoE during data transmissions. One or more of the following may apply.

A WTRU may be configured to support transmissions and/or adaptations to the configurations during the transmissions of data units that include PDUs, PDU sets, and/or data bursts in one or more flows in the UL and/or in the DL (e.g., within the QoS requirements associated with the data units for stabilizing the associated QoS/QoE). The WTRU may support data transmissions within the respective QoS, and/or assist the network with meeting QoS during transmissions based on: configurations, triggering events, and/or conditions/criteria received from the network and/or application.

The WTRU may be configured with one or more conditions and/or configurations associated with the data units to be transmitted to/received from the network. The one or more conditions and/or configurations may be related to and/or may reflect a QoS (e.g., a QoS expected to be achieved) for the data units during transmission to the network (in UL), and/or reception at WTRU (in DL). The one or more conditions and/or configurations may also, or alternatively, be related and/or a change of such expected QoS. If the QoE may be determined as a function of and/or dependent on the QoS, such conditions may also be related to achieving, maintaining and/or improving the QoE performance achievable at WTRU.

Based on such conditions and/or configurations, a WTRU may be configured to selectively map the XR traffic received from higher layers/application. For example, based on such conditions and/or configurations, the WTRU may update any of the mapping configurations, forwarding configurations, the parameters at the protocol stack including SDAP, PDCP, RLC, MAC, PHY, and/or any additional (e.g., new) layers in the AS layers based on the detection of one or more configured triggering conditions (e.g., during data transmissions in UL and/or DL). One or more of the following may apply. The WTRU may be configured to perform 1:1, N: 1 and/or N:M mapping from one or more PDU sets to one or more forwarding configurations (e.g., for enabling flexible utilization of radio bearers and resources while satisfying and maintaining the QoS/QoE).

The WTRU may be configured to perform ordered delivery (e.g., delivery ordered by the application/higher layers) when transmitting and/or receiving the PDUs, PDU sets, and data bursts (e.g., for satisfying and maintaining QoE). The WTRU may also, or alternatively, be configured to discard the (e.g., any of the) PDUs, PDU sets, and/or data bursts that are unable to satisfy the respective QoS/QoE requirements. For example, the WTRU may determine the PDUs, PDU sets, and/or data bursts that are unable to satisfy the respective QoS/QoE requirements based on the intra/inter-PDU set dependency information (e.g., which may minimize overhead and/or improve network capacity).

A WTRU may be configured to perform measurements of XR traffic and the corresponding traffic attributes in the UL and/or received in the DL at the (e.g., any of the) AS layers and/or the (e.g., any of the) application layers. The WTRU may be configured to transmit the (e.g., any of the) reports/indications of the measurements performed by WTRU on the XR traffic attributes. For example, the reports/indication may be periodically transmitted and/or if the WTRU detects a triggering condition.

A WTRU may send information associated with XR traffic, application attributes, and QoS handling (e.g., association of PDUs to PDU sets, association/dependency between PDU sets in one or more data bursts) to the network, which may provide the network information associated with the QoE, the WTRU's actions (e.g., transmission/reception of UP and CP data associated with XR traffic), and/or application configurations/parameters supported by WTRU. The WTRU may transmit the information associated with XR traffic/application via assistance information. The WTRU may transmit the information associated with XR traffic/application via a preferred/desired configuration information (e.g., preferred forwarding and/or resource configurations/parameters to apply in UL/DL). The WTRU may transmit the information associated with XR traffic/application via a status information/indication (e.g., associated with any of AS-layers). The WTRU may transmit the information associated with XR traffic/application via measurement/status reports (e.g., WTRU pose info, channel/link measurements, buffer occupancy measurements). The WTRU may transmit the information associated with XR traffic/application via request/response messages.

The WTRU may transmit the information associated with XR traffic/application periodically (e.g., using one or more configured periodicity values), aperiodically/dynamically (e.g., when detecting triggering events/conditions described herein), as an update message (e.g., when detecting a change in information sent previously) and/or on a semi-persistent basis (e.g., sent with a periodicity value over a time window/duration). If the information associated with XR traffic/application is periodically transmitted, the WTRU may switch between a first periodicity value and a second periodicity value for sending information based on the type of event detected (e.g., change in type of PDU set to be transmitted in UL, buffer occupancy delay is greater than a threshold value). The WTRU may be configured to receive configuration information comprising a threshold value. The WTRU may determine to prioritize one or more protocol data units (PDUs) of a second PDU set over one or more PDUs of a first PDU set in a transmission to be sent in accordance with the first grant.

The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value. The one or more PDUs of the first PDU set may be received prior to the one or more PDUs of the second PDU set being received from the application layer. The one or more PDUs of the first PDU set may be mapped to a first logical channel (LCH) and the one or more PDUs of the second PDU set may be mapped to a second LCH. The one or more PDUs of the first PDU set and the one or more PDUs of the second PDU set may be mapped to the first LCH. The first PDU set may be associated with a first priority and a first payload size. The second PDU set may be associated with a second priority and a second payload size. The indication may comprise the first payload size and/or the second payload size.

Resources used for the transmission indicated by the first grant may be sufficient for including each of the one or more PDUs of the second PDU set. The transmission may comprise at least one PDU of the one or more PDUs of the first PDU set. The information indicating that the second PDU set is prioritized over the first PDU set may comprise an indication regarding at least one PDU of the first PDU set that was not included in the transmission. Resources used for the transmission indicated by the first grant may be insufficient for including each of the one or more PDUs of the second PDU set. The indication that the second PDU set is prioritized over the first PDU set may comprise an indication regarding at least one PDU of the second PDU set that was not included in the transmission. Also, or alternatively, the WTRU may transition between sending information periodically and aperiodically (e.g., based on whether any change and/or amount of change is determined in the information to be reported).

A WTRU may send information/indications to the network via RRC signaling and/or messages (e.g., via SRB1, SRB2, SRB3, SRB4).

A WTRU may send information/indications to the network via control PDUs associated with any of the access stratum (AS) layers (e.g., SDAP control PDU, PDCP control PDU).

A WTRU may send information/indications to the network via an UL MACCE (e.g., a new MAC CE, regular BSR, periodic BSR, padding BSR, enhanced BSR, pre-emptive BSR, elastic BSR which may be scalable/adjustable by sending subsequent indications, possibly without cancelling an earlier BSR).

A WTRU may send information/indications to the network via UCI (e.g., single bit SR, multi-bit SR, feedback, ACK/NACK, CSI report).

A WTRU may send information/indications to the network via a PUCCH transmission.

A WTRU may send information/indications to the network via a PUSCH transmission.

A WTRU may send information/indications to the network via Non-AS (NAS) layer signaling (e.g., PDU session related messages).

A WTRU may send information/indications to the network via application layer signaling/messages.

The information sent by a WTRU to the network may include an indication of one or more of the following: identifiers/IDs; priority of applications supported by the WTRU; data flows associated with the application; the devices associated with the application; data/traffic types associated with the data flows per-application; traffic characteristics and/or parameters of data/traffic associated with any of data/QoS flows, PDU set, and data burst per-application; buffer information (e.g., at application layers/higher layers/AS layers); QoS requirements and/or QoS expectations associated with the respective data; flow synchronization; pose information (e.g., orientation, position/location); capability information associated with connectivity; capability information associated with the WTRU's actions/behaviors; preferred/desired configuration information; indications for activating/deactivating configurations; measurements related to application/AS layer; and/or uncertainty information.

As described herein, the information sent by a WTRU to the network may include identifiers/IDs. One or more of the following may apply. The WTRU may send one or more IDs/indexes including: IDs associated with the application (e.g., application ID, service ID, session ID, application configuration ID); group ID (e.g., associated with group of QoS flows, group of forwarding configurations, group of devices/WTRUs); IDs of individual QOS flows, mapping configurations, forwarding configurations, etc. ; data unit types/message ID (e.g., data burst ID, PDU set ID, PDU ID, IDs associated with pose info, FoV info, media/video frame info); and/or an association ID (e.g., ID and/or sequence numbers indicating the association and/or dependency between one or more PDUs, PDU sets, data bursts, flows).

As described herein, the information sent by a WTRU to the network may include an indication of priority of applications supported by WTRU. One or more of the following may apply. The WTRU may send IDs of the applications supported and/or information associated with the relative/absolute priority values associated with the supported applications.

As described herein, the information sent by a WTRU to the network may include an indication of data flows associated with the application. One or more of the following may apply. The WTRU may send the number of and/or IDs associated with the data/QoS flows supported per-application. The WTRU may also, or alternatively, send information associated with the relative/absolute priority values associated with the data/QoS flows of the different applications supported.

As described herein, the information sent by a WTRU to the network may include an indication of devices associated with the application. One or more of the following may apply. The WTRU may send the number of and/or IDs associated with the supported devices and/or the association of the devices per-application.

As described herein, the information sent by a WTRU to the network may include an indication of data/traffic types associated with the data flows per-application. One or more of the following may apply.

The WTRU may send information associated with different data/QoS flows associated with an application. The data type may include video data (e.g., I-frame data, P-frame data, B-frame data), RGB-D data, 360 degrees video data, haptics data, pose/positioning data, audio data, etc.

As described herein, the information sent by a WTRU to the network may include an indication of traffic characteristics and/or parameters of data/traffic associated with any of data/QoS flows, PDU set, and data burst per-application. One or more of the following may apply. The WTRU may send information associated with traffic characteristics/patterns of the different data/QoS flows, including whether the data is periodic, aperiodic, semi-persistent, quasi-periodic, etc. The traffic characteristics may include the one or more periodicity values of the flow. The WTRU may send information associated with the number of PDUs expected per PDU set (e.g., in one or more flows per-application). The information of number of PDUs per PDU set may also include statistical/distribution information (e.g., mean, min, max, standard deviation values). The information related to the PDU set may include the size of the PDU set (e.g., total payload, number of PDUs in PDU set), an indication of start/first and/or end/last PDU of PDU set, and/or an indication of the association/dependency of the PDUs in a PDU set (e.g., ID of PDU set, importance/priority value).

The WTRU may send information associated with data bursts in one or more data/QOS flows. Information associated with data bursts may include: the number of PDU sets (e.g., instantaneous, mean, max, min), the payload size of data burst in units of bits/bytes (e.g., instantaneous, mean, max, min), periodicity, importance/priority, start and end indication of a data burst (e.g., ID of first PDU/PDU set, ID of last PDU/PDU set), and/or dependency info within data burst and across multiple data bursts (e.g., indicating whether PDU sets in one or more data bursts are dependent). The WTRU may send information related to the jitter in UL and/or in DL. The information related to jitter may be sent on a per flow, per-PDU set, and/or per PDU basis. The information related to jitter may include the range, mean, maximum and minimum value.

The WTRU may send information associated with the importance/priority of the (e.g., any of the) data units (e.g., PDUs, PDU sets, data bursts) to be transmitted/received in UL/DL. If the WTRU detects changes to the UL/DL traffic patterns (e.g., changes to periodicity, changes to mean payload sizes, changes to jitter range), the WTRU may send indications of such changes. The WTRU may send information associated with prediction of traffic patterns in the UL and/or the DL for upcoming data (e.g., timing info indicating the time slot when the data is expected to arrive, size, importance of data to be received, uncertainty and/or confidence level of prediction).

The WTRU may send information associated with whether the data units (e.g., PDUs, PDU sets, data bursts) transmitted in the UL is able to be followed by ACK/NACK feedback indications, which the WTRU may expect to receive from the higher layers (e.g., TCP, RTP) and/or lower layers (e.g., ARQ, HARQ) within a time window/duration after UL transmission. The WTRU may send information associated with whether the data units (e.g., PDUs, PDU sets, data bursts) received in DL is able to be followed by ACK/NACK feedback indications, which the WTRU may expect to transmit to the application layers (e.g., TCP, RTP) and/or lower layers (e.g., ARQ, HARQ) within a time window/duration after DL reception.

As described herein, the information sent by a WTRU to the network may include an indication of buffer information associated with the application layers/higher layers/AS layers. One or more of the following may apply. The WTRU may send information associated with the amount of the data payload and/or the buffer level (e.g., with respect to one or more configured threshold values) at the application (e.g., including data waiting to be delivered to lower layers for UL transmission and/or data received in DL which may be waiting to be delivered to higher layers/application to be consumed/processed). The buffer information may be reported in terms of an estimated and/or measured time duration for the data waiting in the buffer before delivered to lower layers and/or consumed by application.

The buffer information may be reported in terms of the buffered at application/higher layer, new layer, SDAP, PDCP, RLC, MAC, LCG, LCHs. The buffer information may be reported in terms of payload size (e.g., total, instantaneous, mean, max, min) at the granularity of one or more data units (e.g., PDUs, PDU set, data burst). The buffer info rate of data delivered to lower layers and/or rate of data consumption/depletion at higher layers (e.g., determined as ratio of payload size and time duration). The WTRU may send similar information associated with the amount of data payload and/or the buffer level (e.g., with respect to one or more configured threshold values) at the higher layers (e.g., NAS layer) and/or AS layers (e.g., in SDAP, PDCP, RLC, MAC, LCHs, LCGs).

As described herein, the information sent by a WTRU to the network may include an indication of the QOS requirements and/or QOS expectation associated with the respective data. One or more of the following. The WTRU may send the QoS requirements and/or expected QoS of the one or more flows and/or data units (e.g., PDUs, PDU sets, data bursts), including data rate, latency, reliability, absolute/relative priority values, etc. The information associated with QoS requirements may also, or alternatively, include statistical/distribution information such as mean, min, max, and/or standard deviation values. The WTRU may also, or alternatively, indicate that such QOS requirements and/or QoS expectation may be supported on different QoS granularities such as: per-PDU, per-PDU subgroup (e.g., one or more PDUs) within PDU set, per PDU set, per-group of PDU sets, per flow, and/or per session. The WTRU may also, or alternatively, indicate a time window (e.g., start time, duration, end time) during which such QoS requirements and/or QoS expectation may be applicable to the different QoS granularities.

As described herein, the information sent by a WTRU to the network may include an indication of the flow synchronization. One or more of the following may apply. The WTRU may send information associated with synchronization. The information associated with synchronization may include the delay difference between one more PDUs/PDUs sets in one or more correlated flows of the same and/or different devices/users (e.g., visual-tactile synchronization delay, audio-tactile synchronization delay). The synchronization delay difference may refer to the delay between the arrival of the last PDU of a PDU set in a first flow and the arrival of the last PDU of a PDU set in an associated second flow. The WTRU may send information associated with synchronization, including delay difference between unicast and multicast flows (e.g., for 1-to-M and N-to-M interactions).

As described herein, the information sent by a WTRU to the network may include an indication of pose information (e.g., orientation, position/location). One or more of the following may apply. The pose information may be associated with the measurements in the (e.g., any) spatial dimensions (e.g., 6DoF, 3DoF), including but not limited to longitude, latitude, altitude, roll, pitch and yaw in one or more coordinate systems (e.g., cartesian, spherical). The pose information sent by the WTRU may be associated with the orientation and/or position/location of the WTRU. The WTRU may also, or alternatively, send information associated with the movement of the WTRU/user (e.g., rate of movement in terms of linear movement (e.g., distance/sec) and/or rotational movement (e.g., degrees/sec), and/or uncertainty information (e.g., certainty and/or reliability in a predicted pose/movement).

As described herein, the information sent by a WTRU to the network may include an indication of capability information associated with associated with connectivity. One or more of the following may apply. The information associated with interfaces may include the number of and/or types of interfaces (e.g., NR Uu, NR SL, WiLAN, Bluetooth) supported by the WTRU. The capability information associated with interfaces (e.g., interfaces supported by WTRU and/or required by WTRU for supporting any of the WTRU actions/behaviors) may include: the bandwidth, the BWP, the number of carriers, the number of transmit antennas, the number of receive antennas, etc.

As described herein, the information sent by a WTRU to the network may include an indication of capability information associated with WTRU actions/behaviors. The capability information related to WTRU actions (e.g., actions supported by WTRU, such as sensors, camera associated with WTRU, and/or actions required by WTRU), including visual sensing, may include: FoV resolution (e.g., megapixel count); rendered viewports (e.g., viewport ID); FoV size (e.g., 120 degrees); aperture size; startup time; image quality (e.g., min/max range); battery life; sound/audio; and/or display calibration (e.g., corrections applied for distortion and chromatic aberration).

As described herein, the information sent by a WTRU to the network may include an indication of preferred/desired configuration information. One or more of the following may apply. The WTRU may send one or more preferred mapping configurations, forwarding configurations, and/or resource configurations (e.g., CG, DG). The preferred mapping configurations may include specific parameters associated with the forwarding/resource configurations. The preferred mapping configurations may be associated with the WTRU's actions (e.g., actions that may be performed/supported by the WTRU and/or any another associated WTRU/device).

The forwarding configurations sent by the WTRU associated with the supported and/or requested UP/CP configurations (e.g., radio bearers, LCHs, LCGs, links) may include: latency requirements; data rate requirements; reliability requirements; absolute/relative importance/priority values associated with the UP/CP configurations (e.g., radio bearers, logical channels, links); and/or LCP configurations. One or more of following may apply. In an example for PDU, latency requirements may be expressed in terms of Packet Delay Budget (PDB) associated with IP packets/PDUs; and/or LCP configurations.

The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value. The one or more PDUs of the first PDU set may be received prior to the one or more PDUs of the second PDU set being received from the application layer. The one or more PDUs of the first PDU set may be mapped to a first logical channel (LCH) and the one or more PDUs of the second PDU set may be mapped to a second LCH. The one or more PDUs of the first PDU set and the one or more PDUs of the second PDU set may be mapped to the first LCH. The first PDU set may be associated with a first priority and a first payload size. The second PDU set may be associated with a second priority and a second payload size. The indication may comprise the first payload size and/or the second payload size. The forwarding configurations sent by the WTRU may include latency requirements. In relation to the PDU set latency requirements may be expressed in terms of PDU set delay bound (PSDB) and/or Frame Delay Budget associated with the PDU set (e.g., video/media frames).

In relation to a data burst, latency requirements may be expressed in terms of data burst delay bound, and min/max latency associated with PDUs/PDU sets in data burst. The forwarding configurations sent by the WTRU may include data rate requirement (e.g., Mbps). In relation to a PDU, the data rate may be expressed in terms of bit rate (min, max, average, guaranteed) associated with one or more PDUs (e.g., individual PDU, group of PDUs, data burst). In relation to a PDU set, the data rate may be expressed in terms of bit rate (min, max, average, guaranteed) associated with one or more PDU set (e.g., video/media frames). The forwarding configurations sent by the WTRU may include reliability requirements. In relation to the PDU, the reliability may be expressed in Packet Error Rate (PER). In relation to a PDU set, the reliability may be expressed in Frame Error Rate and/or PDU set error rate.

In relation to a data burst, the reliability may be expressed in data burst error rate. The forwarding configurations sent by the WTRU may include LCP configuration. The WTRU may indicate: the LCP rules/restrictions (e.g., restrictions associated with mapping from DRB/LCHs to configured resource grants) that are able to be applied for a set of forwarding/resource configurations (e.g., CG); whether such LCP rules/restrictions may be temporarily changed for a time duration; conditional LCP configurations applicable if certain configured events are detected (e.g., surge in number of PDUs/data with high QoS requirements); and/or fallback/default LCP configurations.

As described herein, the information sent by a WTRU to the network may include an indication of preferred/desired configuration information. The WTRU may associate and/or indicate weight/probability values associated with the respective forwarding/resource configurations (e.g., when sending requests related to a preferred configuration). The weight/probability value may be determined based on the likelihood of a configuration to be applied during transmission and/or other application/AS-layer information/indications. The network may use the weight/probability information, e.g., to determine and/or provide the WTRU a combined configuration. Also, or alternatively, the network may use the weight/probability information to activate/deactivate a configuration that may match with the weight values indicated by WTRU.

As described herein, the information sent by a WTRU to the network may include an indication for activating/deactivating configurations. The WTRU may send an indication to the network to request activation/deactivation of a mapping/forwarding/resource configuration and/or parameters associated with the configurations (e.g., preconfigured in the WTRU). The WTRU may include the ID of the configuration/parameter within the activation/deactivation request. The activation/deactivation request may be accompanied with information associated with the WTRU's relevant action, e.g., splitting/merging QoS flows/PDU sets/data bursts/PDUs.

As described herein, the information sent by a WTRU to the network may include an indication of measurements related to application/AS layer. The WTRU may send RSRP, RSRQ, RSSI measurements of the signals, channels, radio links, carriers, etc. The measurements may be associated with the one or more WTRU actions. The WTRU may send pose/positioning measurements (e.g., location information, pose in 6DoF, rete of user WTRU motion/movement). The WTRU may send measurements and/or estimations related to RTT/MTP, application buffer level, buffer depletion time, depletion rate, etc. The WTRU may send one or more QoS related measurements. The QoS related measurement may relate to arrival time and number of PDUs/PDU sets/data bursts received possibly over a time duration, change in the QoS (e.g., increase/decrease in data rate, latency, reliability), time-to-live associated with the PDUs/PDU sets/data bursts, and/or time remaining for delivering the PDUs/PDU sets/data bursts.

As described herein, the information sent by a WTRU to the network may include an indication of uncertainty information. For any of the information sent/reported by WTRU, including application layer info (e.g., application layer/QoE measurements) and AS-layer information (e.g., PDU set payload size, PDU set arrival time), the WTRU may send uncertainty associated with the information. If the WTRU performs prediction and/or estimation of a parameter (e.g., PDU set latency), the WTRU may indicate the uncertainty associated with the estimation/prediction to network.

A WTRU may receive configuration information from the network. One or more of the following may apply. A WTRU may receive configuration information that may be used to ensure/stabilize QoS/QoE during UL and/or DL transmissions of data units, PDUs, PDU sets, and/or data bursts in one or more data/QoS flows. The WTRU may send the transmission comprising at least one of the one or more PDUs of the second PDU set in accordance with the first grant. The transmission may comprise information indicating that the second PDU set is prioritized over the first PDU set. The information indicating that the second PDU set is prioritized over the first PDU set may be transmitted in an Uplink Control Information (UCI) indication.

The UCI indication may comprise information indicating remaining PDUs of the first PDU set and a remaining time associated with the first PDU set and information indicating remaining PDUs of the second PDU set and a remaining time associated with the second PDU set. The one or more PDUs of the first PDU set may be received prior to the one or more PDUs of the second PDU set being received from the application layer. The one or more PDUs of the first PDU set may be mapped to a first logical channel (LCH) and the one or more PDUs of the second PDU set may be mapped to a second LCH. The one or more PDUs of the first PDU set and the one or more PDUs of the second PDU set may be mapped to the first LCH. The first PDU set may be associated with a first priority and a first payload size. The second PDU set may be associated with a second priority and a second payload size. The indication may comprise the first payload size and/or the second payload size.

The information indicating that the second PDU set is prioritized over the first PDU set may be transmitted in a scheduling request (SR), a buffer status report (BSR), or a delay status report (DSR). The WTRU may also receive a second grant. The one or more PDUs of the first PDU set may be received prior to the one or more PDUs of the second PDU set being received from the application layer. The one or more PDUs of the first PDU set may be mapped to a first logical channel (LCH) and the one or more PDUs of the second PDU set may be mapped to a second LCH. The one or more PDUs of the first PDU set and the one or more PDUs of the second PDU set may be mapped to the first LCH. The first PDU set may be associated with a first priority and a first payload size. The second PDU set may be associated with a second priority and a second payload size. The indication may comprise the first payload size and/or the second payload size.

Resources used for the transmission indicated by the first grant may be sufficient for including each of the one or more PDUs of the second PDU set. The transmission may comprise at least one PDU of the one or more PDUs of the first PDU set. The information indicating that the second PDU set is prioritized over the first PDU set may comprise an indication regarding at least one PDU of the first PDU set that was not included in the transmission. Resources used for the transmission indicated by the first grant may be insufficient for including each of the one or more PDUs of the second PDU set. The indication that the second PDU set is prioritized over the first PDU set may comprise an indication regarding at least one PDU of the second PDU set that was not included in the transmission.

The WTRU may receive the configuration information from network periodically (e.g., with one or more configured periodicity values), aperiodically/dynamically (e.g., status indication/information and/or request/request messages), and/or on semi-persistent basis (e.g., sent with a periodicity value over a time window/duration). For example, the WTRU may receive the configuration information via RRC signaling and/or messages (e.g., dedicated/unicast signaling via any of SRBs, broadcast/SIB). The WTRU may receive the configuration information via control PDUs associated with any of the AS layers (e.g., SDAP control PDU, PDCP control PDU). The WTRU may receive the configuration information via a DL MAC CE. The WTRU may receive the configuration information via DCI. The WTRU may receive the configuration information via a PDCCH transmission. The WTRU may receive the configuration information via a PUSCH transmission. The WTRU may receive the configuration information via Non-AS (NAS) layer signaling (e.g., a PDU Session Establishment Response and/or a PDU Session Modification Command). The WTRU may receive the configuration information via application layer signaling/messages.

The configuration information which may be received by WTRU from the network may include one or more: mapping/forwarding/resource configurations and/or parameters; AS layer status information/indications; validity information; and/or threshold values.

As described herein, the configuration information received by WTRU from the network may include mapping/forwarding/resource configurations and/or parameters. The WTRU may receive one or more configurations and/or sets of configuration parameters. The configurations and/or sets of configuration parameters may be applied at different layers of AS protocol stack (e.g., RRC, SDAP, PDCP, RLC, MAC, PHY, and/or any new layer).

The configurations parameters received by the WTRU that may be applied at the SDAP/PDCP may include: 1-to-1, 1-to-M and/or N-to-M mapping configurations, markings/indications/IDs to apply (e.g., associated with handling QOS flows, PDU sets, data busts, association info between PDU sets and data bursts), and/or range of values associated with importance/priority info to identify in the PDUs/PDU sets. As described herein, an SDAP/PDCP mapping configuration may refer to information that is used to map a packet at the SDAP layer to a PDCP entity/sublayer.

The configurations parameters received by the WTRU that may be applied at the PDCP may include: IDs and sequence numbers to apply, RoCH configuration, security/encryption parameters, and/or packet duplication configuration.

The configurations parameters received by the WTRU that may be applied at the RLC may include parameters for AM/UM/TM operation.

The configurations parameters received by the WTRU that may be applied at the MAC may include: LCH parameters (e.g., priority, PBR, BSD for PDU and/or PDU set level), LCP configurations (e.g., rules/restrictions/policy for PDU and/or PDU set level handling, time duration for changing between different LCP rules/policy), and/or configurations for multiplexing/assembly The configurations parameters received by the WTRU that may be applied at the PHY layer may include: MCS, and/or HARQ configurations.

As described herein, the configuration information received by WTRU from the network may include mapping/forwarding/resource configurations and/or parameters. The WTRU may receive one or more resource configurations. The WTRU may receive resource configurations (e.g., configuration information) that include configured grant resources/configurations and/or dynamic grant resources/configurations for UL data transmissions. The configuration information may comprise one or more threshold values associated one or more time threshold values (e.g., remaining time, buffering time, delay budget), frequency threshold values (e.g., bandwidth size, number of component carriers, number of resource blocks), and data threshold values (e.g., payload size of PDUs, PDU sets or data bursts). The network may determine a suitable threshold value based on multiple factors (e.g., dependent on network implementation), including, for example, capability information received from the WTRU, assistance information on traffic received from the core network and/or application function, etc.

The WTRU may send the transmission comprising at least one of the one or more PDUs of the second PDU set in accordance with the first grant. The transmission may comprise information indicating that the second PDU set is prioritized over the first PDU set. The information indicating that the second PDU set is prioritized over the first PDU set may be transmitted in an Uplink Control Information (UCI) indication. The UCI indication may comprise information indicating remaining PDUs of the first PDU set and a remaining time associated with the first PDU set and information indicating remaining PDUs of the second PDU set and a remaining time associated with the second PDU set.

The information indicating that the second PDU set is prioritized over the first PDU set may be transmitted in a scheduling request (SR), a buffer status report (BSR), or a delay status report (DSR). The WTRU may receive a second grant. The parameters associated with CG resources/configurations may include any of: a periodicity, start offset, duration, BWPs, numerology/SCS values, number of PRBs, number of occasions, number of PUSCH slots per occasion, maximum number/duration/length of PUSCH, one or more MSC values for the grant, antenna ports, etc. The WTRU may receive resource configurations that include semi-persistent scheduling (SPS) resources/configurations for DL data receptions.

The parameters associated with SPS resources/configurations may include: periodicity, start offset, duration, BWPs, numerology/SCS values, number of PRBs, number of occasions, number of PDSCH slots per occasion, maximum number/duration/length of PDSCH, one or more MCS values for the grant, antenna ports, etc. The WTRU may receive resource configurations that include dynamic grant resources for UL data transmission (e.g., triggered by UCI, SR, BSR, MAC CE). The WTRU may receive resource configurations that include dynamic scheduling resources for DL data receptions (e.g., triggered by DCI, PDCCH, MAC CE).

As described herein, the configuration information received by WTRU from the network may include mapping/forwarding/resource configurations and/or parameters. The WTRU may receive a (e.g., at least one) set of configuration parameters (e.g., associated with default configurations), which may be activated and/or used during normal scenarios for transmitting/receiving data. The WTRU may also, or alternatively, receive another set of configuration parameters that may be associated with exceptional operation and/or may be activated and/or used if a triggering events/conditions is detected (e.g., as described herein).

A WTRU may receive default priority values associated with the resource configurations (e.g., CG). A first resource configuration may be associated with a first priority value and second resource configuration may be associated with a second priority value. The first and second resource configurations may be associated with the same application, and a first set of priority values may be configured to achieve a first (e.g., default) QoS performance (e.g., default latency, default data rate) and a second set of priority values may be intended to achieve a second (e.g., exceptional) QoS performance (e.g., surge/burst data rate, very low latency) for the PDUs/PDU sets using the first and second resource configurations during transmission.

The WTRU may send the transmission comprising at least one of the one or more PDUs of the second PDU set in accordance with the first grant. The transmission may comprise information indicating that the second PDU set is prioritized over the first PDU set. The information indicating that the second PDU set is prioritized over the first PDU set may be transmitted in an Uplink Control Information (UCI) indication. The UCI indication may comprise information indicating remaining PDUs of the first PDU set and a remaining time associated with the first PDU set and information indicating remaining PDUs of the second PDU set and a remaining time associated with the second PDU set. The information indicating that the second PDU set is prioritized over the first PDU set may be transmitted in a scheduling request (SR), a buffer status report (BSR), or a delay status report (DSR). The WTRU may receive a second grant.

As described herein, the configuration information received by WTRU from the network may include AS layer status information/indications. That AS layer status information/indications may include identifiers/IDs. The WTRU may receive information associated with one or more IDs to apply during transmission/reception, including for example: WTRU IDs (e.g., C-RNTI, I-RNTI, NAS IDs, TMSI/IMSI); IDs associated with application (e.g., application ID, service ID, session ID, application configuration ID); a group ID (e.g., associated with group of QOS flows, group of forwarding configurations, group of devices/WTRUs); IDs associated with individual QoS flows, mapping configurations, forwarding configurations, etc. ; data type/message ID (e.g., PDU set ID, data burst ID, flow ID, PDU ID); and/or a resource configuration ID (e.g., CG IDs, SPS IDs). The AS layer status information/indications may also include status of forwarding/resource configurations.

The WTRU may receive information associated with QoS achieved/achievable (e.g., latency) when using one or more forwarding/resource configurations. Such information may be received by the WTRU in terms of the data-rate, latency (e.g., expected, remaining latency), reliability, priority achievable/achieved when transmitting/receiving any of the data units including PDUs, and/or PDU sets and data bursts. The WTRU may also receive statistical/relative/absolute information associated with the achieved/achievable QOS, in terms of mean, max, min, standard deviation, etc. The AS layer status information/indications may further include flow control information. The WTRU may receive (e.g., explicit and/or implicit) flow control indications from the network. The flow control indication may indicate whether to start/increase/decrease/suspend/stop transmission of PDUs/PDU sets (e.g., in terms of achieving an indicated rate of transmission, latency, reliability, in one or more forwarding configurations).

As described herein, the configuration information received by WTRU from the network may include validity information. The WTRU may receive validity information associated with the forwarding/resource configurations. The validity information may indicate whether/if the configurations are considered to be valid and/or invalid (e.g., based on one or more of triggering events/conditions being detected). The WTRU may also receive information indicating if the configurations are to be deactivated and/or released when determining them to be invalid. The WTRU may receive information associated with whether the configurations are to be considered valid/invalid based on the RRC state of the WTRU (e.g., CONNECTED, INACTIVE, IDLE) and/or when transitioning between different RRC states.

As described herein, the configuration information received by WTRU from the network may include threshold values, including, for example: a buffer occupancy threshold; PDU/PDU set payload size threshold values; Delay threshold values; Delay difference threshold values; Expected time threshold values; Expected data rate (EDR) threshold values; Expected reliability threshold values; and/or Correlation time window.

If the configuration information received by WTRU from the network includes a buffer occupancy threshold, one or more of the following may apply. The buffer occupancy threshold values associated with the (e.g., any of the) forwarding configurations may indicate the maximum/minimum amount of data units in one or more granularities/types including PDUs, PDU sets and data bursts (e.g., in terms of total payload size/volume) that are (e.g., are able to be) included in the buffer (e.g., application layer buffer, SDAP buffer, PDCP buffer, LCH buffer).

If the configuration information received by WTRU from the network includes a PDU/PDU set payload size threshold values, one or more of the following may apply. The payload size threshold values may be associated with one or more upper and/or lower bound values corresponding to the total size of payload (e.g., in the units of bits and/or bytes) of one or more PDUs, PDU sets and/or data bursts. Also, or alternatively, the payload size threshold values may be associated with one or more upper and/or lower bound values corresponding to the total number of PDUs in a PDU set, and/or total number of PDU sets in a data burst.

If the configuration information received by WTRU from the network includes delay threshold values, one or more of the following may apply. The delay threshold values may be associated with one or more upper and/or lower bound values corresponding to maximum/minimum delay value associated with reception, buffering and/or transmission of any of data units (e.g., PDUs, PDU sets, data bursts). Such delay threshold values may be used to identify and/or determine the maximum/minimum latency tolerated by the network, application and/or WTRU (e.g., as a result of delays due to processing, jitter, transmission, congestion, etc.).

If the configuration information received by WTRU from the network includes Delay difference threshold values, one or more of the following may apply. The delay difference threshold values may be associated with one or more upper and/or lower bound values corresponding to the difference between a first delay value (e.g., default delay) and a second delay value (e.g., new/updated delay value).

If the configuration information received by WTRU from the network includes an expected time threshold values, one or more of the following may apply. The WTRU may receive one of more expected time threshold values and/or expected time of arrival (ETA) threshold values corresponding to the expected time for receiving any of the data units including one or more PDUs, PDU sets, and data bursts. The PDUs/PDU sets may be the first/last PDU/PDU set associated with a PDU set/data burst and/or any of the subsequent PDUs/PDU sets after receiving the earlier PDUs/PDU sets. The ETA threshold values may be associated with the expected latency for the second PDU/PDU set after receiving/transmitting the first PDU/PDU set with a first latency value.

The second PDU/PDU set may correspond to the last PDU/PDU set of a PDU set/data burst. The ETA threshold values may be associated with an expected latency for the PDUs/PDU set in a second associated flow after receiving/transmitting the PDUs/PDU set in a first flow. An ETA threshold value may be associated with a time duration and/or timer value. The WTRU may start a timer at a time instance when receiving/transmitting the first PDU/PDU set and stop the timer when the timer expires at the time instance corresponding to the threshold time value and/or when receiving/transmitting the second PDU/PDU set (e.g., first and second PDU may be associated with the same PDU set/data burst).

If the configuration information received by WTRU from the network includes expected data rate (EDR) threshold values, one or more of the following may apply. The WTRU may receive one or more expected data rate threshold (EDR) values associated with the data rate expected for receiving/transmitting PDUs/PDU sets in one or more PDU sets, data bursts, and/or flows. The data rate may correspond to any of the following units: PDUs/PDU sets per second, frames per second, bits/bytes per second, etc. The EDR threshold values may be associated with an expected data rate for the second PDU/PDU set (e.g., after receiving/transmitting the first PDU/PDU set with a first data rate value). The EDR threshold values may be associated with the expected data rate for the PDUs/PDU sets in a second associated flow (e.g., after receiving/transmitting the PDUs/PDU sets in a first flow with a first data rate value).

If the configuration information received by WTRU from the network includes expected reliability threshold values, one or more of the following may apply. The WTRU may receive one or more expected reliability threshold (EER) values associated with the expected reliability for receiving PDUs/PDU sets in one or more PDU sets, data bursts, and/or flows. The reliability values may correspond to any of the following units: packet error rate, frame/PDU set error rate, probability of error, etc. The reliability values may correspond to an upper bound for the rate of PDU sets that have been processed by the transmitter (e.g., WTRU in UL and/or base station in DL) of a AS layer protocol (e.g., RLC layer) where all of the PDUs in the PDU set are not successfully delivered by a corresponding receiver (e.g., base station in UL and/or WTRU in DL) to the upper layer (e.g., PDCP layer). The EER threshold values may be associated with the expected reliability for the second PDU/PDU set (e.g., after receiving/transmitting the first PDU/PDU set with a first reliability value). The EER threshold values may be associated with the expected reliability for the PDUs/PDU sets in a second associated flow (e.g., after receiving/transmitting the PDUs/PDU sets in a first flow with a first reliability value).

If the configuration information received by WTRU from the network includes a correlation time window, one or more of the following may apply. The correlation time window may correspond to the minimum time difference between one or more (e.g., two) triggering events (e.g., buffer level measurements, PDU/PDU set arrival time), where the triggering events are considered as correlated if they occur within the correlation time window. When the events (e.g., two events) occur at time instances beyond the correlation time window, they may be considered as independent. The WTRU may use the correlation time window determine whether to send an indication of the triggering events to the network (e.g., indicating change in latency, and/or change in QoS).

A WTRU may be configured with triggering events/conditions that may be used to stabilize QoS/QoE during data transmissions/receptions. The WTRU may be configured with one or more events/conditions related to triggering one of the WTRU actions described above, including sending assistance information/indications/reports to network, receiving configuration/assistance information from network, sending indication/request for changing resource configurations, sending indication/request for changing forwarding configurations, etc.

The triggering events/conditions may be used in relation to QoS/QoE stabilization and/or for meeting QoS expectations when transmitting/receiving XR data units (e.g., PDUs, PDU sets, data bursts) in one or more QOS flows. The triggering events/conditions may be used to determine if a respective action is to be performed by WTRU. The triggering events/conditions may be used to determine when (e.g., at what time instance/slot) an action is to be performed by WTRU (e.g., when any of events/condition/criteria described below is satisfied). The WTRU may determine/select one or more forwarding configurations (e.g., DRBs, LCHs) and/or resource configurations (e.g., CG, SPS, DG) for stabilizing/meeting the QoS/QoE based on detection of one or more triggering events/conditions.

The triggering conditions/events may include: indications/information from the network; indications/information from application/higher layers; buffer status and loading at forwarding configurations (e.g., DRBs/LCHs); change in configuration(s) at the WTRU; timing/timestamp information (e.g., associated with the expected QoS); measurements on a Uu link(s); Compensation based on expected QoS; properties associated with the link/channel to which a forwarding configuration may be associated; and/or Detection of QoS events (e.g., surge in payload size, high importance data).

As described herein, the triggering conditions/events may include indications/information from the network. The WTRU may receive an indication/information associated with the expected/achievable QoS/QoE for transmission and/or reception of any XR data units over the Uu link (in UL and/or DL) from the network (e.g., gNB). The information may be received semi-statically, during/upon configuration, and/or dynamically. The WTRU may trigger an action (e.g., determining/selecting a mapping, forwarding, and/or resource configuration) based on the indication/information received from network, as described herein.

The expected/achievable QoS/QoE may be indicated on the basis of per PDU, per-PDU set, per data burst, per-QoS/data flow, per forwarding configuration, per-resource configuration.

The WTRU may receive (e.g., implicitly receive) the information associated with expected/achievable QoS/QoE from gNB based on one or more of the following: number of time HARQ feedback that may be received, size and/or timing for allocation of resource grants (e.g., configured grant, dynamic grants), allocation of retransmission grant corresponding to one or more forwarding configurations (e.g., LCHs/DRBs/BWPs), de-prioritization of PUSCH/grant for one or more LCHs due to intra/inter WTRU prioritization, etc. The WTRU may perform any of the configured WTRU action(s) in response to receiving an indication from the network (e.g., in RRC, MAC CE, other control PDU and/or DCI). The indication received by the WTRU may be related to a change/update in the forwarding/resource configuration at WTRU and/or an expected QoS/QoE associated with the one or more XR data units and/or flows.

As described herein, the triggering conditions/events may include indications/information from application/higher layers. For example, the WTRU may perform any of the WTRU actions described herein in response to receiving an indication from application/higher layers. Such indications may include information associated with a change of traffic characteristics/patterns associated with the generation/processing/reception of XR data units in one or more flows. The application may indicate information associated with the expected number of QoS flows which may be associated with the application, expected number of PDUs per PDU set, expected frame/PDU set in a subsequent time instances (e.g., next frame generation instance), expected change in the distribution of importance/priority of PDUs generated, expected increase/decrease in latency (e.g., due to processing at codec/application), jitter for delivering the data units in UL and/or DL, expected change in the time-to-live associated with the data units, expected change in WTRU/user motion/movement (e.g., increase/decrease in rate of motion), etc. to the WTRU.

The WTRU may receive an indication of the arrival of one or more data units (e.g., in a batch/burst) from the application to the WTRU (for UL) and/or from application to the network (in DL). The information associated with the arrival of the PDUs may include the expected timing (e.g., time slot/frame) of data unit generation at the application, and/or the expected timing of reception at the WTRU. For example, this information may be indicated to the WTRU via timestamps, and/or sequence numbers. The WTRU may be triggered to perform any of WTRU action(s) described herein based on an indication of importance/priority for the transmitting data units. The WTRU may trigger an action (e.g., change forwarding/resource configuration, etc.) for sending PDUs (e.g., delayed PDUs) with compensation (e.g., low latency) in response to receiving an indication that includes an importance/priority value higher than a threshold.

As described herein, the triggering conditions/events may include buffer status and/or loading at forwarding configurations (e.g., DRBs/LCHs). The buffer status may include a condition associated with any of the following and/or combinations of measurements (e.g., compared to a threshold): the amount of XR data units in one or more buffers associated with forwarding configurations, possibly over a period of time; the rate of arrival/departure of data units in one or more buffers associated with forwarding configurations; the average, max, min size/volume of the data units in an buffers associated with forwarding configurations (e.g., number of PDUs in LCH buffer); the Measured amount of time spent by one or more data units in buffers associated with forwarding configurations; and/or the number of forwarding configurations meeting a condition/threshold associated with the amount of data, arrival rate, data units (e.g., total payload size), etc.

The WTRU may perform any of the actions described herein (e.g., change the forwarding configuration and/or change resource configuration) if a (e.g., at least one) data unit in a forwarding configuration (e.g., UL LCH buffer waiting to be transmitted in UL and/or DL LCH/higher layer buffer waiting to be processed) is in the buffer for a period of time larger than a threshold. For example, a WTRU may perform any of the actions described herein (e.g., send a report and/or status indication) if the buffer status of s forwarding configuration exceeds a threshold. Other buffer status metrics that may be monitored for determining the expected QoS may include: the number of data units buffered that are above/below a configured threshold in one or more associated forwarding configurations, and/or the rate of data units arrival/departure in the buffer with respect to a configured arrival/departure rate.

The WTRU may determine the number of data units received over a time duration/window, which may be used to determine whether the rate of PDUs received (e.g., from higher layers for UL transmission and/or from network for DL reception) is within the range expected for the QoS. For example, a WTRU may use such a time duration/window to determine whether the PDUs received from the network may be received within an RTT latency. The WTRU may then determine/select a mapping configuration for adjusting/compensating the expected QoS if the data units are received outside of the range expected for QoS.

As described herein, the triggering conditions/events may include changes in configuration(s) at the WTRU. The WTRU may be triggered to perform a WTRU action(s) (e.g., sending an indication/report to network) when determining a change to a mapping configuration, forwarding configuration and/or resource configuration, including changing at least one of the parameters at the mapping configuration (e.g., mapping a QOS flow to a new forwarding configuration), DRB/LCHs (e.g., priority, PDB, PBR, PSDB, PSER), LCP configuration and/or resource configuration/parameters (e.g., CG, DG, SPS). For example, the WTRU may be triggered to perform a WTRU action(s) when the CDRX/DRX configuration and/or any of the associated parameters applied at the WTRU is modified/updated, which may impact the transmission/reception pattern and/or QoS (e.g., RTT) achievable during data transmission.

As described herein, the triggering conditions/events may include timing/timestamp information (e.g., associated with expected QOS). The WTRU may track the timing related information (e.g., timestamp, sequence number, marker and/or timing control PDU) in the one or more data units received in an earlier time window for determining the latency and/or jitter. The timing information may then be used for determining the expected QoS for upcoming/new data units in a next time window. The timing information may be determined/indicated as a deadline/latency bound and/or survival time that may be satisfied on a per-PDU, per-PDU set, per-data burst and/or per-QoS flow basis. Such timing information may be determined across one or more associated/correlated QoS flows, including the correlated UL flows, and correlated DL flows. The timing information may also, or alternatively, be determined/indicated on a count basis (e.g., data unit count).

The WTRU may trigger an action (e.g., determining mapping/forwarding configuration), as described herein, when determining the timing information and its impact on whether the expected QOS may/may not be met. The WTRU may send information associated with the expected QoS based on measurements associated with the amount of time that data units spend in a given forwarding configuration (e.g., elapsed time from reception of data units from higher layers to transmission in UL, elapsed time from reception of data units in DL to forwarding to higher layers).

The WTRU may send information/indications/reports to the network (as described herein) periodically and/or based on a setting/expiration of a configured timer.

As described herein, the triggering conditions/events may include measurements on Uu link(s).

The WTRU may perform measurements over the Uu link (e.g., corresponding to RSRP, RSSI, CQI and CSI) for determining the expected QoS. The channel/load measurements made over a certain configured time duration may indicate whether the data units are able to achieve the expected QoS during transmission and/or reception and/or exceed the QoS budget (e.g., PSDB). The WTRU may trigger an action (e.g., determining mapping configuration), as described herein, based on the measurements on the Uu link.

The WTRU may determine the Uu link conditions based on the number of ARQ/HARQ (ACK/NACK) feedback messages and/or ARQ/HARQ retransmissions made over the one or more HARQ processes associated with the forwarding configurations applied for sending the data units. The expected QOS may be determined based on a (e.g., configured) mapping function between the feedback/ReTx count in UL and/or DL and expected QoS. As an example, a ReTx count above a threshold may translate to decreased performance on the Uu link/channel and/or reduced QoS expectations. The WTRU may determine the channel/link conditions based on CSI reports transmitted to and/or received from the network.

The WTRU may be triggered to perform WTRU action(s) and/or send an indication to network when channel measurements made (e.g., RSRP, RSSI, RSRQ, CQI, CSI) on the Uu link increase/decrease with respect to a configured threshold and/or remains above/below a threshold for a certain time duration. The WTRU may be triggered to perform WTRU action(s) when one or more QoS related measurements (e.g., latency measured for data units in one or more forwarding configurations) exceed a certain threshold. The WTRU may trigger an action, as described herein, based on determination of a time duration/jitter, a change in the time duration/jitter between reception of consecutive PDUs associated with an PDU set and/or consecutive PDU sets associated with a data burst, and/or reception of data units in one or more correlated flows in UL and/or DL. For example, the WTRU may use an increase/decrease in the jitter between consecutive PDUs for determining whether the processing load at application/higher layer is high/low. To determine the time duration, the WTRU may set a timer when a first data unit arrives and reset the timer when an associated second data unit arrives.

As described herein, the triggering conditions/events may include compensation based on an expected QoS. For example, the WTRU may be triggered to perform WTRU action(s) based on determination of expected QoS for one or more data units (e.g., where the expected QoS may indicate that the PDUs are either delayed and/or will arrive early) during UL transmission and/or DL reception. The WTRU may trigger an action such that the delayed and/or early data units may be transmitted with a determined compensation amount by selecting suitable resource configurations (e.g., CG and/or DG resources). The action(s) may be triggered when detecting a change (e.g., higher/lower) in the expected QOS for the data units by a certain threshold. The WTRU may determine that the delayed PDU is to be sent using a forwarding/resource configuration that satisfies a compensation amount (e.g., where the compensation amount may be determined by subtracting the expected latency from actual latency).

As described herein, the triggering conditions/events may include properties associated with the link/channel that a forwarding configuration may be associated with. A WTRU may be configured with a property specific to the forwarding configuration/link/channel such as: a forwarding configuration/link/channel priority; and/or a configuration parameter enabling/disabling the specific action for the forwarding configuration/link/channel. If a forwarding configuration/link/channel is configured with high priority, the WTRU may change any configuration (e.g., with respect to an initial and/or default configuration). The WTRU may change the parameters of a forwarding configuration associated with high priority as long as the change impacts (e.g., only impacts) other lower priority forwarding configurations.

As described herein, the triggering conditions/events may include detection of QoS events (surge in payload size, high importance data). QoS events may include surge events associated with an increase in the number of data units and/or data volume (e.g., over a time window) and/or may be indicated/marked with high importance/priority. Likewise, other QoS event may include QoS deflation associated with a decrease in the number of data units and/or data/payload volume over a time window. A QOS event may also, or alternatively, include when a WTRU detects poor (e.g., below a threshold) radio conditions. For example, poor radio conditions may be detected based on measurements, increased retransmissions, increased NACKs of uplink packets, etc.

The WTRU may be triggered to perform WTRU action(s) when detecting one or more QoS events (e.g., if the indicated/determined the duration the QoS events are expected to persist). The WTRU may perform other WTRU actions that may result in falling back to the default configurations (e.g., after the end of the detected QoS events). If WTRU detects a surge event (e.g., increase in total payload and/or number of PDU sets), the WTRU may trigger an action to change the resource configuration in the UL and/or the DL (e.g., CG and/or SPS updated for the duration of the surge). If the WTRU determines a reduction in the surge and/or an end of the surge event, the WTRU may fallback to using the default resource configuration in UL and/or DL (e.g., default CG and/or SPS).

A WTRU may determine dependency/association information corresponding to XR data units. For example, a WTRU may determine whether the PDUs in one or more flows transmitted in UL and/or received in DL are inter-dependent and/or associated with a data unit (e.g., PDU set, data burst). The WTRU may determine the association of the PDUs to PDU set and/or data burst based on an indication (e.g., an explicit indication) and/or parameters/identifiers (e.g., implicit parameters/identifiers) detectable by WTRU in the PDUs and/or flows. Upon determining the association/dependency of the PDUs with a PDU set and/or association of PDUs/PDU sets with a data burst, the WTRU may perform certain actions that may result in using similar forwarding treatment during delivery of the PDUs in UL and/or DL.

The parameters/identifiers for determining the association of PDUs with data units may be configured in the WTRU (e.g., via RRC signaling, NAS-layer signaling and/or application/higher layer signaling). For example, the parameters/identifiers used by the WTRU for identifying the association of PDUs with the data units may include one or more of the following: identifiers/IDs/indexes/sequence numbers; priority/importance info associated with flows; temporal/timing information in associated flows; spatial/pose information in associated flows; and/or explicit indications from application/higher layers/AS-layers.

As described herein, the parameters/identifiers used by the WTRU for identifying the association of PDUs with the data units may include identifiers/IDs/indexes/sequence numbers. The WTRU may determine that a first PDU and/or a second PDU in the same QoS flow and/or different QoS flows are associated with a PDU set (e.g., if the WTRU detects common IDs/indexes/sequence numbers associated with the PDU set). For example, the ID may be detected within the PDUs (e.g., in header and/or payload) in one or more QoS flows. The ID of the PDU set and/or application associated with the PDU set may be preconfigured in the WTRU. Similar sets of IDs/indexes/sequence numbers may be used for identifying the association of one or more PDU sets with a data burst.

As described herein, the parameters/identifiers used by the WTRU for identifying the association of PDUs with the data units may include priority/importance information associated with flows. The WTRU may determine that a first PDU and/or a second PDU in one or more QOS flows are associated with a PDU set, e.g., based on detection of common and/or similar importance/priority indications in the PDUs (e.g., in header and/or payload) in the QoS flows. Such importance/priority indications may be related to spatial and/or temporal indications. The WTRU may determine the PDUs that are associated with a PDU set based on the importance/priority indications detected by WTRU (e.g., in PDU header and/or payload) may be above/below one or more importance/priority threshold values. Similar importance/priority indications may be used for identifying the association between PDUs/PDU sets with a data burst.

As described herein, the parameters/identifiers used by the WTRU for identifying the association of PDUs with the data units may include temporal/timing information in associated flows. A WTRU may determine that a first PDU and/or a second PDU in one or more QoS flows are associated with a PDU set, e.g., based on the PDUs that are received and/or arrive at the WTRU within a time duration/window. The time duration/window may correspond to the time difference between the reception time of a first PDU (e.g., at t1) and a second PDU (e.g., at t2) within the same QoS flow. The time duration/window may also, or alternatively, correspond to the time difference between the reception time of a PDU in first QoS flow (e.g., at t1) and the reception time of a PDU in second flow (e.g., at t2). In The WTRU may determine that the first and second PDUs in the same and/or different QoS flows may be associated with a PDU set if the time difference (e.g., t2−t1) is less than a time duration/window threshold value. The time duration/window threshold value may be associated with the frame-rate used by the application/higher layer (e.g., 60Hz, 120Hz) for generating the PDUs/PDU sets. A similar approach may be applied for determining the association between PDUs/PDU sets with a data burst based on the temporal/timing information. The WTRU may determine that the first and second PDUs in one or more flows are associated with a PDU set, and/or may be associated with a data burst, based on a common format and/or granularity of the timing information (e.g., timestamps, packet count, sequence numbers) carried in the PDUs (e.g., headers, payload).

As described herein, the parameters/identifiers used by the WTRU for identifying the association of PDUs with the data units may include spatial/pose information in associated flows. A WTRU may determine that a first PDU and/or a second PDU in one or more QoS flows are associated with a PDU set and/or a data burst, e.g., based on the PDUs carrying the spatial information corresponding to common spatial parameters/IDs. The spatial parameters/IDs may include one or more of the following: direction/orientation of FoV of the user WTRU, slice/tile of the video/media frame, location info (e.g., coordinates of the WTRU), pose info, etc. The spatial parameters/IDs may be determined by the WTRU based on detection of certain PDUs carrying spatial information (e.g., pose/control PDU which may be identified by WTRU based on data type identifiers) and/or detection of other PDUs that include spatial information within the PDUs (e.g., in header and/or payload).

As described herein, the parameters/identifiers used by the WTRU for identifying the association of PDUs with the data units may include explicit indications from application/higher layers/AS-layers. The WTRU may determine that a first PDU and/or a second PDU in one or more QoS flows are associated with a PDU set and/or a data burst, e.g., based on receiving an explicit indication/message from higher-layers/AS-layers in WTRU and/or network. The WTRU may receive, in the indication, the timing information (e.g., periodicity, burst time window/duration) during which the PDUs are associated. In addition to the timing information (e.g., burst duration), the WTRU may determine that the PDUs are uncorrelated and/or not associated with a PDU set and/or a data burst.

A WTRU may select a forwarding configuration at the AS layers for mapping XR data units during UL transmissions. For example, a WTRU may receive one or more data units from higher layers/application. The WTRU may map the data units to selected one or more forwarding configurations (e.g., DRBs, and/or LCHs) when performing UL transmission of the data units (e.g., PDUs, PDU sets, data bursts). The WTRU may send the transmission comprising at least one of the one or more PDUs of the second PDU set in accordance with the first grant. The transmission may comprise information indicating that the second PDU set is prioritized over the first PDU set. The information indicating that the second PDU set is prioritized over the first PDU set may be transmitted in an Uplink Control Information (UCI) indication. The UCI indication may comprise information indicating remaining PDUs of the first PDU set and a remaining time associated with the first PDU set and information indicating remaining PDUs of the second PDU set and a remaining time associated with the second PDU set.

The information indicating that the second PDU set is prioritized over the first PDU set may be transmitted in a scheduling request (SR), a buffer status report (BSR), or a delay status report (DSR). The WTRU may receive a second grant. One or more of the following may apply for the XR data units including PDU sets and data bursts.

Resources used for the transmission indicated by the first grant may be sufficient for including each of the one or more PDUs of the second PDU set. The transmission may comprise at least one PDU of the one or more PDUs of the first PDU set. The information indicating that the second PDU set is prioritized over the first PDU set may comprise an indication regarding at least one PDU of the first PDU set that was not included in the transmission. Resources used for the transmission indicated by the first grant may be insufficient for including each of the one or more PDUs of the second PDU set. The indication that the second PDU set is prioritized over the first PDU set may comprise an indication regarding at least one PDU of the second PDU set that was not included in the transmission.

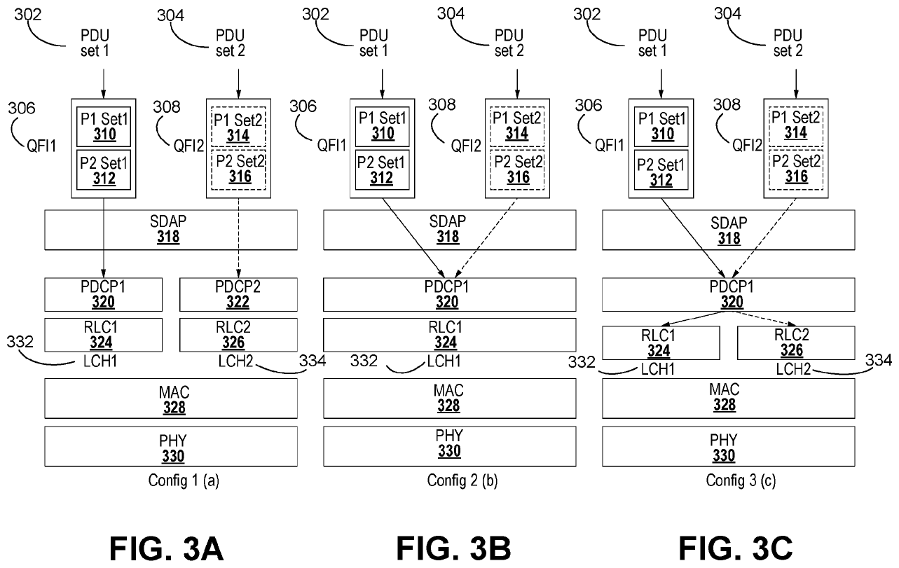

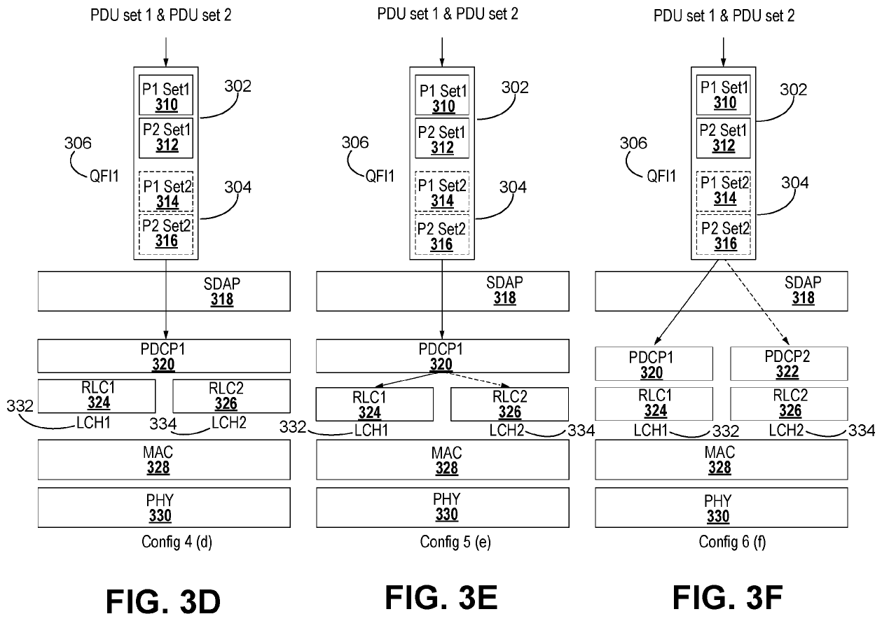

FIGS. 3A-3F illustrate examples associated with a WTRU selecting and/or using a configured forwarding configurations at AS layers for mapping XR data units during UL transmission using: a first configuration (e.g., as shown in FIG. 3A); a second configuration (e.g., as shown in FIG. 3B); a third configuration (e.g., as shown in FIG. 3C); a fourth configuration (e.g., as shown in FIG. 3D); a fifth configuration (e.g., as shown in FIG. 3E); and a sixth configuration (e.g., as shown in FIG. 3F).

As shown in FIG. 3A, a WTRU may receive one or more PDUs associated with PDU set 1 302 and PDU set 2 304 in QFI1 306 and QFI1 308, respectively. PDU set 1 302 comprises of PDU1 (P1 Set1) 310 and PDU2 (P2 Set1) 312. PDU set 2 304 comprises of PDU1 (P1 Set2) 314 and PDU2 (P2 Set2) 316. The received PDU sets may be mapped to DRB1 (e.g., PDCP1 320) and DRB2 (e.g., PDCP2 322) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318, and/or at a new sublayer/subfunction/entity above PDCP1 320 and PDCP2 322, such as a higher/common PDCP sublayer). Each PDCP entity (e.g., PDCP1 320 and PCDP2) may be configured to support in-order delivery of PDUs in PDU set 1 302 and PDU set 2 304, respectively. For example, each PCDP entity may add SNs to the PDUs associated with the PDU set 1 302 and PDU set 2 304, respectively. The PDUs of PDU set 1 302 and PDU set 2 304 may be mapped to LCH1 332 and LCH2 334, e.g., corresponding to RLC1 324 and RLC2 326, respectively. The MAC 328 entity/sublayer may ensure that the QoS of the PDU sets (e.g., PSDB) in the respective LCHs are met, e.g., based on the PDU set parameters (e.g., priority) and/or using an LCP procedure, during scheduling and/or multiplexing of the PDU sets into one or more TBs and UL transmission.

As shown in FIG. 3B, a WTRU may receive one or more PDUs associated with PDU set 1 302 and PDU set 2 304 in QFI1 306 and QFI1 308, respectively. The received PDU sets may be multiplexed/mapped to DRB1 (e.g., PDCP1 320) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318 and/or at PDCP1 320). The PDUs of PDU set 1 302 and PDU set 2 304 may be mapped to LCH1 332, e.g., corresponding to RLC1 324. The MAC 328 entity/sublayer may ensure that the QoS of the PDU sets (e.g., PSDB) in LCH1 332 are met, e.g., based on the PDU set parameters (e.g., priority, SNs) and/or using an LCP procedure (e.g., during scheduling and/or multiplexing of the PDU sets into one or more TBs and UL transmission).

As illustrated in FIG. 3C, a WTRU may receive one or more PDUs associated with PDU set 1 302 and PDU set 2 304 in QFI1 306 and QFI1 308, respectively. The received PDU sets may be mapped to DRB1 (e.g., PDCP1 320) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318 and/or at PDCP1 320). The PDUs of PDU set 1 302 and PDU set 2 304 may be mapped to LCH1 332 and LCH2 334, e.g., corresponding to RLC1 324 and RLC2 326 respectively. The MAC 328 entity/sublayer may ensure that the QoS of the PDU sets (e.g., PSDB) in the respective LCHs are met, e.g., based on the PDU set parameters (e.g., priority) and/or using an LCP procedure (e.g., during scheduling and/or multiplexing of the PDU sets into one or more TBs and UL transmission).

As illustrated in FIG. 3D, a WTRU may receive one or more PDUs associated with PDU set 1 302 and PDU set 2 304 in QFI1 306. The received PDU sets may be mapped to DRB1 (e.g., PDCP1 320) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318 and/or at PDCP1 320). The PDUs of PDU set 1 302 and PDU set 2 304 may be mapped to LCH1 332, e.g., corresponding to RLC1 324. The MAC 328 entity/sublayer may ensure that the QoS of the PDU sets (e.g., PSDB) in LCH1 332 are met, e.g., based on the PDU set parameters (e.g., priority) and/or using an LCP procedure (e.g., during scheduling and/or multiplexing of the PDU sets into TBs and UL transmission).

As illustrated in FIG. 3E, a WTRU may receive one or more PDUs associated with PDU set 1 302 and PDU set 2 304 in QFI1 306. The received PDU sets may be mapped to DRB1 (e.g., PDCP1 320) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318 and/or at PDCP1 320). The PDUs of PDU set 1 302 and PDU set 2 304 may be mapped to LCH1 332 and LCH2 334, e.g., corresponding to RLC1 324 and RLC2 326 respectively. The MAC 328 entity/sublayer may ensure that the QoS of the PDU sets (e.g., PSDB) in the respective LCHs are met, e.g., based on the PDU set parameters (e.g., priority) and/or using an LCP procedure (e.g., during scheduling and/or multiplexing of the PDU sets into one or more TBs and UL transmission).

As illustrated in FIG. 3F, a WTRU may receive one or more PDUs associated with PDU set 1 302 and PDU set 2 304 in QFI1 306. The received PDU sets may be mapped to DRB1 (e.g., PDCP1 320) and DRB2 (e.g., PDCP2 322) at the SDAP 318 sublayer/entity. For supporting in-order delivery of the PDU sets, the sequence numbers (SNs) may be added to PDU set 1 302 and PDU set 2 304 (e.g., at any of the SDAP 318 sublayer/entity, a new sublayer/entity below SDAP 318 and/or at a new sublayer/subfunction/entity above PDCP1 320 and PDCP2 322, such as a higher/common PDCP sublayer). Each PDCP entity (e.g., PDCP1 320 and PCDP2) may be configured to support in-order delivery of PDUs in PDU set 1 302 and PDU set 2 304, respectively. For example, each PCDP entity may add SNs to the PDUs associated with the PDU set 1 302 and PDU set 2 304, respectively. The PDUs of PDU set 1 302 and PDU set 2 304 may be mapped to LCH1 332 and LCH2 334, e.g., corresponding to RLC1 324 and RLC2 326 respectively. The MAC 328 entity/sublayer may ensure that the QoS of the PDU sets (e.g., PSDB) in the respective LCHs are met, e.g., based on the PDU set parameters (e.g., priority) and/or using an LCP procedure (e.g., during scheduling and/or multiplexing of the PDU sets into one or more TBs and UL transmission).

A WTRU may determine whether/how to discard XR data units based on the detection of triggering events. For example, a WTRU may be configured to discard one or more data units associated with XR data units (e.g., PDUs, PDU sets, and data bursts and/or groups thereof) based on the detection of triggering events/conditions (e.g., as described herein). The triggering events/conditions may be associated with QoS for the delivery of the respective data units. The triggering conditions for discarding any of the data units may be configured in the WTRU by the network (e.g., via RRC signaling).

A WTRU may receive one or more data units that include PDUs, PDU sets, data bursts, and/or groups thereof (e.g., from higher layers). The WTRU may forward the data units, upon processing (e.g., allocating sequence numbers, adding protocol layer header), to lower layers. The WTRU may transmit the data units in the UL to the base station. When forwarding the data units (e.g., PDUs of the PDU set) to the lower layers (e.g., RLC, MAC 328, PDU) for further processing (e.g., prior to UL transmission), the WTRU may store/buffer a copy of the PDUs of the PDU set.

Storing/buffering of the data units may be performed at an entity/sublayer configured in the WTRU. For example, the entity/sublayer may be used to discard the (e.g., any of the data) units. The storing/buffering of the data units may be performed at a different entity/sublayer (e.g., where discarding of the data units is performed). The different entities/sublayers where the WTRU perform storing/buffering/discarding of the data units (e.g., PDUs, PDU sets, data bursts and/or groups thereof) may include a layer/sublayer/subfunction within and/or at: SDAP 318, PDCP, RLC, MAC 328 (e.g., at one or more LCHs), PHY 330 and/or a new layer/sublayer/subfunction.

A WTRU may discard and/or drop the (e.g., any of the) data units that have been explicitly and/or implicitly indicated to be discarded and/or any of the conditions for discarding are met. When discarding, the WTRU may also, or alternatively, discard other data units that may be dependent on the data units to be discarded (e.g., when discarding conditions are met). For example, in a PDU set that includes N PDUs that are inter-dependent/associated with each other and where k of the N PDUs have been successfully transmitted, the WTRU may discard the remaining N-k PDUs (e.g., if the conditions for discarding at least one of the remaining PDUs are met).

The WTRU may determine the association and/or dependency information for identifying which PDUs to be discarded based on pre-configuration of the dependency information, reception of an indication from higher layer and/or network, and/or detection of markings in the PDU/PDU set headers (e.g., PDUs associated with each other may contain common IDs). Similar association and dependency information between PDU sets in one or more data bursts and/or flows may also be used for determining whether to discard the one or more PDU sets (e.g., when conditions for discarding are met).

A WTRU may discard the (e.g., any of the) stored/buffered data units (e.g., PDUs, PDU sets, data bursts and/or groups thereof) based on one or more of the following: receiving status indication/report from the network; receiving a discard indication; and/or expiration of discard timer.

As described herein, a WTRU may discard stored/buffered data units based on the reception of status indication/report from the network. For example, the WTRU may receive a status indication that indicates successful reception (e.g., ACK) of one or more PDUs (e.g., IDs) associated with the PDU set and/or one or more PDU sets (e.g., IDs) associated with a data burst/flow. The WTRU may discard the indicated PDUs/PDU sets. The WTRU may receive (e.g., within the status indication) an indication of one or more of the PDUs and/or PDU sets that are not successfully received (e.g., NACK). If the WTRU receives an indication of the PDUs/PDU sets that are not successfully received and/or if the conditions associated with meeting the QoS of the data units are still valid, the WTRU may not discard the data units.

If the PSDB is still achievable with the remaining PDUs of PDU set at WTRU, the WTRU may not discard the PDUs/PDU sets. Tf the PDUs indicated with NACK may be (re)transmitted within PSDB, the WTRU may not discard the PDUs/PDU sets. If the priority of the PDUs/PDU sets that have received a NACK is above a threshold value, the WTRU may not discard the PDUs/PDU sets. If the conditions associated with meeting the QoS of the data units are no longer valid, the WTRU may discard the data units.

The WTRU may discard any of the data units (e.g., remaining and/or transmitted) based on receiving an indication from lower layers (e.g., RLC/MAC 328) that indicates successful reception of the data units (e.g., ACK) at the receiving lower layer entity at the network. Also, or alternatively, the WTRU may not discard the (e.g., any of the) remaining and/or transmitted data units based on receiving an ACK indication from lower layers (e.g., RLC/MAC 328) unless other conditions for discarding are met (e.g., expiry of discard timer, and/or reception of status indication). For example, the lower layers may have successfully received the data units at the base station and/or may have transmitted an ACK indication, and the higher layers (e.g., PDCP/SDAP 318) may not have successfully decoded the received data units (e.g., due to failures associated with security, integrity protection, CRC, RoCH, etc.). In such scenarios, the WTRU may be requested to retransmit the data units.

As described herein, a WTRU may discard stored/buffered data units based on the reception of a discard indication. The WTRU may discard the (e.g., any of the) remaining and/or dependent data units (e.g., PDUs, PDU sets and/or groups thereof) based on receiving an indication (e.g., explicit and/or implicit indication) to discard the PDU. For example, the WTRU may discard the data units based on receiving a status indication (e.g., PDCP status indication) from the receiving entity (e.g., PDCP) in the network. The status indication may include a discard indication and/or the IDs of one or more PDUs/PDU sets to be discarded.

A WTRU may discard the (e.g., any of the) data units based on receiving an indication to discard, e.g., from higher layers/application. If the WTRU receives a discard indication from higher layers/application, the WTRU may generate and transmit a control message/command (e.g., PDCP control PDU) to the network. For example, the control message/command may indicate that the WTRU is discarding of (e.g., some of) the data units. Also, or alternatively, the control message/command may include a cause indication (ID) that indicate the cause (e.g., reason) for the WTRU discarding the data units (e.g., due to application/higher layer indication).

The WTRU may know that the higher/application layers are applying a form of Forward Error Control (FEC) / Error Correction Coding (ECC) such that the application may be able to recover some data units (e.g., PDU sets) despite the loss of some constituent components (e.g., some PDUs of that PDU set). In such a scenario, the discarding entity (e.g., transmitting PDCP entity in the WTRU) may wait (e.g., always wait) until the discarding entity receives an indication (e.g., an explicit indication from the application) to discard any PDUs belonging to a PDU set.

The WTRU (e.g., transmitting PDCP entity in the WTRU) may have received an indication from the receiving entity (e.g., receiving PDCP entity in the gNB) to discard some PDUs in the PDU set. In such a scenario, the WTRU may wait for an indication (e.g., an explicit indication from the application) before discarding any data units.

A WTRU (e.g., transmitting PDCP entity in the WTRU) may determine (e.g., assume) that the receiving entity (e.g., receiving PDCP entity in the gNB) is aware of the FEC/ECC used at the receiving end, and/or that the receiving entity has taken that into account when sending a discard indication to the transmitting entity. In such a scenario, the WTRU (e.g., transmitting PDCP entity in the WTRU) may (e.g., may always) discard the remaining PDUs in a PDU set in response to receiving an indication from the receiving entity (e.g., receiving PDCP entity in the gNB).

As described herein, a WTRU may discard stored/buffered data units based on the expiry of discard timer. The WTRU may be configured with a discard timer associated with the delivery of one or more data units (e.g., PDUs, PDU sets, data bursts and/or groups thereof). The duration/length of the discard timer may be associated with a delay bound (e.g., PSDB) for transmitting a group of PDUs belonging to a PDU set and/or a data burst. That data (e.g., all the data) corresponding to a (e.g., one) data unit (e.g., PDU set) may arrive at the WTRU (e.g., at PDCP sublayer in WTRU) at the same time, such that the PSDB becomes the same as the PDB of the individual PDCP SDUs. The data may arrive in a staggered way, such that the PSDB is different to the respective PDBs of the individual PDCP SDUs.

The WTRU may be aware that traffic patterns are different (e.g., depending on the XR application generating the traffic). In such a scenario, the WTRU may determine to use PDB and/or PSDB, e.g., depending on the knowledge of the traffic pattern of the application (e.g., staggered and/or same-time arrival). For example, a WTRU may start the discard timer (e.g., at PDCP entity) based on receiving and/or transmitting a group of one or more PDUs associated with the PDU set/data burst. The WTRU may discard the (e.g., any of the) PDUs that are remaining in the WTRU and/or associated with the PDUs that are not successfully transmitted based on expiration of the discard timer. The WTRU may detect that a condition for discarding the PDUs is met (e.g., WTRU may receive a status/discard indication from the network) while the discard timer is running. If the WTRU detects that a condition for discarding the PDUs is met while the discard timer is running, the WTRU may stop/reset the discard timer and discard the remaining PDUs.

The WTRU may restart and/or extend a discard timer during transmission of the (e.g., any of the) data units, e.g., based on receiving an indication (e.g., an explicit and/or implicit indication from network and/or application/higher layer). The WTRU may be configured with a discard timer associated with a PDCP SDU (e.g., a legacy PDCP SDU). The WTRU may be configured to start one or more (e.g., multiple) timers for the (e.g., all) PDCP SDUs that belong to a XR data unit (e.g., PDU set). In such a scenario, at the expiration any of the one or more timer(s) corresponding to a (e.g., any) PDCP SDU of that data unit (e.g., PDU set), the WTRU may discard other SDUs (e.g., all the other SDUs) belonging to that data unit (e.g., PDU set), e.g., even if the timer(s) for the other PDCP SDUs have not expired/reached their deadline.

As described herein, a WTRU may discard stored/buffered data units based on the time duration spent by the data units in one or more buffers associated with the WTRU (e.g., any buffers at the application layer and AS layers, such as SDAP 318, PDCP, LCH, MAC 328). The duration of time that the data units are in a buffer may be determined, e.g., as the time elapsed since the arrival of the data units in the buffer. For example, the WTRU may discard the (e.g., any of the) data units based on determining that the time the data units have spent the buffer in WTRU is greater than and/or less than one or more configured threshold values. Also, or alternatively, the WTRU may be awaiting a resource allocation for UL transmission (e.g., before discarding the data units).

When discarding the (e.g., any of the) data units (e.g., PDUs, PDU sets, data bursts and/or groups thereof), the WTRU may send an indication to network and/or higher layer/application indicating the information associated with discarding of the data units (e.g., IDs of PDUs/PDU sets discarded). Also, and/or alternative, if any of the conditions for discarding are met, the WTRU may send an indication to network and/or higher layer/application indicating the information associated with discarding of the data units (e.g., IDs of PDUs/PDU sets discarded).

A WTRU may be configured to support in-order delivery of XR traffic during data transmission/reception. For example, a WTRU may be configured to perform in-order delivery of the data units associated with PDUs, PDU sets, data bursts, and/or groups thereof when transmitting and/or receiving the data intended for the application/higher layers in the UL and/or the DL. The procedures, criteria, and/or conditions for performing in-order delivery of the data units may be configured in the WTRU by the network (e.g., via RRC signaling). The network may send indications on changes to the procedures, criteria, and/or conditions to perform in-order delivery of data units to the WTRU.

In certain scenarios (e.g., related to UL transmission), a WTRU may receive one or more data units that include PDUs, PDU sets, data bursts, and/or groups thereof from higher layers. The WTRU may forward the data units to lower layers and, upon processing, transmit the data units in the UL, e.g., such that the data is received at the network in an order intended by application, higher layers and/or network. In the DL, the WTRU may receive the one or more data units from the network. The WTRU may determine that the received data units are arranged and/or staggered in a given order (e.g., particular order intended by the application, higher layers and/or network) prior to forwarding the data to the higher layers.

The operation/functionalities related to in-order delivery of the data units performed by the WTRU may one or more of: allocation of sequence numbers (SNs) and/or IDs; retransmission of missing data units; and/or buffering (e.g., to perform ordered delivery). One or more of the following may apply.

A WTRU may be configured (e.g., in relation to in-order delivery of data units) to perform an allocation of sequence numbers (SNs) and/or IDs. The SNs and/or identifiers (IDs) may be allocated/included for different granularities of data units, e.g., including on a per-PDU basis, per-PDU set basis, per-data burst basis, and/or per a group of any one or more of the aforementioned data units. For example, for each of the PDU sets received from higher layers, the WTRU may include a per-PDU set SN and/or ID. Such per-PDU set SN and/or ID may be common and/or included in the (e.g., all the) PDUs associated with the PDU set. The format in which the WTRU may assign the SN to the PDU sets may be sequential (e.g., on a first-come-first-serve basis) such that the PDU set arriving first in time may be assigned the number 1 followed by the PDU set arriving next assigned the number 2, etc.).

PDUs within the PDU set may also, or alternatively, be assigned SN sequentially in their order of arrival within the PDU set. PDUs and PDU sets may be assigned numbers to associate the dependencies between them. The WTRU may assign (1,1), (1,2), (1,3) to PDUs 1, 2 and 3 of PDU set 1 302, respectively. The WTRU may allocate the SNs to the data units in an incremental manner based on criteria. The criteria may include: the order in which the data units are received from higher layers; markings (e.g., SNs, IDs, timestamps, priority/importance); and/or indication by higher layers/application in the data units (e.g., header of data unit) and time window in which the data units are received.

A first PDU set received from a higher layer may be allocated with a first SN and a second PDU set received following the first PDU set may be allocated with a second SN (e.g., where the value of the second SN may be higher than the first SN). The WTRU may allocate and/or add SNs to the data units, e.g., by using a starting SN value and incrementing the SN values up to an end/upper bound value (e.g., super-frame number value). Beyond the end/upper bound value the WTRU may restart the allocation of the SNs to the new data units received. The upper bound value for the SNs may be associated with a validity timer value, a timer bond value, and/or delay bound value. In such a scenario, the WTRU may continue to increment the SNs during allocation from the start SN value until the WTRU reaches the end/upper bound (e.g., so long as the validity time value is valid). If the validity timer is determined to not be valid and/or an associated timer has expired prior to reaching the end/upper bound, the WTRU may reset the SNs allocation and use the start SN value when allocating the SNs to the new data units received.

A WTRU may be configured (e.g., in relation to in-order delivery of data units) to perform retransmission of missing data units. In certain scenarios (e.g., UL transmissions), the WTRU may retransmit the (e.g., any of the) data units (e.g., PDUs, PDU sets, data bursts and/or groups thereof) that are successfully received and/or received in-order by the network. Such retransmission of the data units may be performed if the WTRU receives a status indication and/or a request indication from the network.

For example, the WTRU may retransmit one or more of the missing data units based on receiving (e.g., in the status/request indication) and indication that the SNs of the successfully received data and/or the SNs of the data not received by network.

The WTRU may also, or alternatively, retransmit the (e.g., some of the) data units that are dependent and/or associated with previously transmitted data and/or data requested to be retransmitted by network. If the WTRU retransmits some of the missing data units, the WTRU may apply a different forwarding configuration (e.g., use more robust MCS, use different links, channels, beams, resources, resource sets), which may increase the reliability during retransmission. In certain scenarios (e.g., DL reception), the WTRU may identify the SNs of the data units that have not been received in order and/or are missing at the WTRU. The WTRU may generate and/or transmit an indication to network (e.g., status indication, request message) indicating the SNs of the successfully received data and/or SNs of the data not received by the WTRU. The indication (e.g., status/request indication) may be transmitted by the WTRU periodically and/or based on detecting one or more preconfigured events (e.g., expiry of a timer, number of missing data (e.g., SNs) are above a threshold value).

A WTRU may be configured (e.g., in relation to in-order delivery of data units) to perform buffering (e.g., which may promote ordered delivery). For example, the WTRU may buffer the (e.g., any of the) data units transmitted in the UL, e.g., based on receiving an indication (e.g., status indication, request message) from network. Also, or alternatively, the WTRU may retransmit the buffered data units, e.g., based on receiving an indication (e.g., status indication, request message) from network. The WTRU may discard the buffered data units, e.g., upon receiving an indication of a successful in-order reception of data units.

The WTRU may receive any of the data units from application/higher layer and/or the WTRU may buffer the one or more data units that are received out-of-order (e.g., data with later SNs/IDs/timestamps may be received before data with earlier SNs/IDs/timestamps) prior to sending the data units to lower layers. In other scenarios, the data may be received in-order. In certain scenarios (e.g., DL reception) the WTRU may buffer the (e.g., any of the) data units received out-of-order (e.g., data with later SNs may be received before data with earlier SNs) until that WTRU receives the (e.g., all the) data in-order, e.g., before sending the data to application/higher layers.

The WTRU may buffer the data received out-of-order in the UL and/or the DL for a certain (e.g., configured) time duration before forwarding the data and/or discarding the buffered data. The time duration may be configured, e.g., depending on the data unit (e.g., size of data unit) that was received out-of-order. If the (e.g., some of the) PDUs within a PDU set and/or the (e.g., some of the) PDUs within a data burst are received out of order, the time duration may be smaller (e.g., as compared to if some of the PDU sets are received out-of-order). The time duration may be configured, e.g., depending on the number of data units that were received out of order. The more data units that are received out of order, the longer the time duration for the WTRU to buffer the out-of-order data before forwarding/discarding the buffered data.

A WTRU may have operations/functionalities associated with in-order delivery of the data units (e.g., PDUs, PDU sets, data bursts) at different entities/sublayers, as described herein. The different entities/sublayer may include one or more sublayers/subfunctions within and/or at: the SDAP 318, the PDCP, the RLC, the MAC 328 (e.g., at one or more LCHs), the PHY 330, and/or a new sublayer.

The WTRU may receive one or more data units (e.g., PDU sets) from higher layers in one or more data/QoS flows. If the WTRU receives one or more data units from higher layers in one or more data/QoS flows, the WTRU may be configured to map the received data units to one or more (e.g., multiple) DRBs (e.g., PDCP entities/sublayers). In such a scenario, the techniques associated with in-order delivery (e.g., allocation of SNs) may be performed at any of the: SDAP 318 sublayer/entity; a new layer between SDAP 318 and the one or more PDCP entities/sublayer; and/or a subfunction/sublayer within PDCP. A subfunction/sublayer within PDCP may be located at an upper level of PDCP, which may be common to the (e.g., all of the) lower level PDCP entities to which the PDU sets received from higher layers/SDAP 318 are mapped to.

A WTRU may be configured to map the data units (e.g., PDU sets) received in one or more data/QoS flows to a single DRBs (e.g., PDCP entity/sublayer). If a WTRU is configured to map the data units received in one or more data/QoS flows to a single DRBs, the functionality for supporting in-order delivery (e.g., allocation of SNs) may be performed at the SDAP 318 sublayer/entity and/or at the PDCP sublayer/entity.

A WTRU may be configured with updated (e.g., enhanced) BSR tables. The updated BSR tables may have more values/levels, which may, e.g., be used by the WTRU to indicate the data in its buffer(s) with a higher granularity. The updated BSR tables may allow a decrease in the quantization error. The updated BSR table may be used together with other BSR tables (e.g., existing and/or legacy BSR tables). The updated BSR table may replace the existing (e.g., legacy) BSR tables.

The use of the updated BSR table may be applicable for (e.g., only for) XR traffic. Also, or alternatively, the use of the updated BSR table may be applicable for any type of traffic. The use of the updated BSR table may be configurable, e.g., such that the WTRU may be able to determine if the updated BSR table should be used and/or if another (e.g., legacy) BSR table should be used. The WTRU may determine the BSR table to use based on the amount of data in the WTRU's buffer. If the amount of data in the WTRU buffer is above a threshold (e.g., a pre-configured threshold by the gNB, e.g., during an RRC (re)configuration and/or preconfigured by the WTRU), the WTRU may determine to use updated BSR table. If the amount of data in the WTRU buffer is below the threshold, the WTRU may determine to use another (e.g., legacy) BSR table.

The WTRU may determine to use (e.g., always use) another (e.g., existing/legacy) BSR table (e.g., except in cases where there may be congestion at the network, such that the network may determine to minimize quantization error, e.g., as a result of the BSR through more accurate reporting of the amount of data in the WTRU's buffer. The WTRU may detect congestion at the network, e.g., through an indication (e.g., an explicit indication) from the network (e.g., via RRC signaling, MAC 328 CE, DCI). Also, or alternatively, the WTRU may detect congestion at the network as a result of measurements (e.g., low throughput). The WTRU may detect congestion at the network based on receiving a number of NACKs (e.g., beyond a preconfigured threshold) for the data that the WTRU has sent in the UL. The WTRU may detect congestion at the network through detection of one or more (e.g., several) other WTRUs and/or devices close to the WTRU (e.g., within a predefined radius of the WTRU), e.g., through measurements over sidelink and/or any other interfaces (e.g., unlicensed, Wi-Fi).

The WTRU may be configured to use one or more updated BSR tables. The WTRU may determine to use a first updated BSR table over another updated BSR table based on the factors described herein (e.g., size of data in the WTRU's buffer, following detection of congestion at the network, etc.).

A WTRU may be configured to trigger and/or transmit a short BSR if the WTRU has data buffered in a (e.g., only one) LCG. Also, or alternatively, a WTRU may be configured to trigger and/or transmit a long BSR if the WTRU has data buffered in more than one LCG (e.g., up to 8 LCGs). A short BSR may only include a number of bits (e.g., 8 bits), e.g., with certain bits (e.g., 3 bits) used to identify the LCG with buffered data, leaving the WTRU with the remaining bits (e.g., 5 bits) to indicate the amount of data in its buffer. With more granularity added to the BSR table to accommodate XR traffic (e.g., large data units, PDU sets, video frames, data bursts, etc.), the WTRU may be able to indicate more indices pertaining to more levels/values in the BSR table.

One or more additional bits may be added to the short BSR format. One or more additional bits may be added to the long BSR format. One or more additional bits may be added to the extended BSR format and/or the restriction whereby the extended BSR format is limited to IAB may be lifted.

The WTRU may be configured with additional BSR formats for usage by the WTRU. A ‘medium’ BSR format may carry a number of bits between the short BSR format and the long BSR format. Similarly, a ‘very long’ BSR format may carry a number of bits larger than the long BSR format. The usage of a long BSR while the WTRU may only have data in a small number of LCG (e.g., one and/or two LCG) may involve unnecessary overhead. As such, A WTRU may use a (e.g., legacy) long BSR format even if the WTRU has data in a (e.g., only one) LCG. The WTRU may use one or more updated BSR formats if the WTRU has data in a low number of LCGs (e.g., one and/or two LCGs).

The WTRU may be configured with a bitmap format as one or more BSR formats. Each bit in a bitmap corresponding to N bits (e.g., one or more octets) may represent the payload size of data (e.g., in one or more LCHs), which may be above and/or below a threshold value.

The WTRU may use the updated BSR format for (e.g., only for) XR traffic. In an example, the WTRU may use the new/enhanced BSR format for any type of traffic. Usage of the updated BSR format may depend on certain parameters, such as the amount of data in the WTRU's buffer, the number of LCHs and/or LCGs which carry the UL data, the type of UL data, etc. When transmitting data (e.g., PDU sets, data bursts), such as video frames with larger payload sizes, the WTRU may use the updated BSR format. When transmitting data with smaller payload sizes (e.g., control/pose data) the WTRU may use another BSR format (e.g., existing short BSR format).

A WTRU may trigger reporting of QoE measurements of data received in the DL. A WTRU may be configured to perform QoE measurements associated with the consumption, processing, and/or playout of the data received in the DL at the application/higher layer and/or report the QoE measurements to the network.

The application/higher layer in the WTRU may consume the (e.g., any of the) data units (e.g., PDUs, PDU sets, data bursts and/or groups thereof) received from the network in the DL. In such a scenario, the WTRU may forward the data units received in the DL to the application/higher layers. The WTRU may have visibility of the data forwarded to application/higher layers in terms of buffering, consumption, and/or processing. The WTRU may be configured (e.g., by network) to perform measurements of the forwarded data and report the measurements to the network. The WTRU may be configured to measure the time duration that the data units forwarded to the higher layers are kept in the higher layer buffer prior to consumption/processing. Such information may be used to determine how and/or if the forwarding configurations (e.g., resource allocation) and/or expected QoS during DL transmissions/receptions are to be adjusted.

The WTRU may receive configuration information from the network and/or application/higher layers for performing QoE measurements and/or triggering events associated with QoE measurements. The configuration information may include one or more of: forwarding and/or resources configurations; QoE measurement metrics; and/or threshold values corresponding to QoE measurement events.

As described herein, the configuration information received by a WTRU may include a forwarding and/or resources configurations. The WTRU may be configured with one or more SRBs/DRBs (e.g., SRB4 and/or any new SRB) for reporting the (e.g., any of the) QoE measurements. The WTRU may be configured with one or more resource configurations (e.g., CG) and parameters (e.g., different periodicity values, different grant sizes, different offsets, different priority values). The WTRU may be configured with a first resource configuration (e.g., default CG config with default periodicity value) that may be indicated as activated. The WTRU may be configured with one or more other resource configurations (e.g., non-default resource configurations) that may be indicated as being deactivated. The WTRU may be configured to use a given CG as default resource configuration and dynamic grant (DG) as a non-default resource configuration, and/or vice-versa. The WTRU may receive configuration information comprising a threshold value.

The WTRU may receive a first grant. The WTRU may receive a second grant. The first grant may be a first dynamic grant or a first configured grant. The WTRU may determine to prioritize one or more protocol data units (PDUs) of a second PDU set over one or more PDUs of a first PDU set in a transmission to be sent in accordance with the first grant. The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value. The WTRU may send the transmission comprising at least one of the one or more PDUs of the second PDU set in accordance with the first grant. The transmission may comprise information indicating that the second PDU set is prioritized over the first PDU set.

As described herein, the configuration information received by a WTRU may include QoE measurement metrics. The WTRU may be configured to measure timing information, e.g., including any of the start time, time duration, and end time (e.g., in terms of mean, min, max, standard deviation) associated with buffering of the (e.g., any of the) one or more data units (e.g., PDUs, PDU sets, data bursts and/or groups thereof) at the higher layer/application. Such measurements on timing information may be configured on a per-data unit, per-buffer, per-application, per group of data unit-basis, and/or per-flow basis. The WTRU may be configured to measure the buffer depletion rate (e.g., data rate in units of bits/s at which the data in the buffer is consumed by application/higher layers) corresponding to one or more buffers at the higher/application layers.

Also, or alternatively, the WTRU may be configured to measure and/or report on the payload size (e.g., in units of bits/bytes and/or number of PDUs) of the data buffered at one or more buffers at the higher/application layers. Also, or alternatively, the WTRU may be configured to measure any of the following higher layer parameters: RTT/motion-to-photon latency, rendered viewports/FoV, survival/validity duration for data in buffer, discarding events triggered by application/higher layers, delay/synchronization difference between multiple correlated flows (e.g., visual-tactile and audio-tactile flows).

As described herein, the configuration information received by a WTRU may include threshold values (e.g., that correspond to QoE measurement events). For example, the threshold values may include upper and/or lower bound threshold values corresponding to max/min buffer depletion rate, max/min buffering time duration, max/min buffering payload size, and higher layer parameters. Also, or alternatively, the threshold values may include upper and/or lower bound threshold values corresponding to normal playout rate and/or normal buffer depletion rate. Such normal playout/depletion rate may correspond to the default rate.

Upon receiving the configuration information, a WTRU may perform measurements of the QoE metrics on the data forwarded to the higher layers/application. If the QoE measurements of buffer depletion rate are within the upper/lower bound values corresponding to normal values, the WTRU may use the default resource configuration for reporting the QoE measurements to the network (e.g., using default periodicity). If the QoE measurements of the buffer depletion rate are above and/or below a corresponding threshold value, the WTRU may determine the resource configuration to use (e.g., based on the QoE measurement). If the buffer depletion rate is lower than a threshold value (e.g., indicating slower consumption of data at the application layer and/or longer buffering duration), the WTRU may determine to use a dynamic grant as the resource configuration, e.g., by triggering an SR and/or BSR for reporting the QoE measurements to the network. Similarly, the WTRU may determine to use a dynamic grant (e.g., by triggering SR and/or BSR), if the buffer depletion rate is higher than a threshold value, which may indicate faster consumption of data at the application layer. The WTRU may transmit the QoE measurements using the DG allocated by the network.

The WTRU may select a (e.g., preconfigured) resource configuration (e.g., CG config) with higher and/or lower periodicity for reporting the QoE measurements (e.g., based on the performed measurements). For example, the WTRU may select a CG config with higher periodicity if the buffer depletion rate is measured to be higher than a threshold value. Similarly, the WTRU may select a CG config with lower periodicity if the buffer depletion rate is measured to be lower than a threshold value.

When determining a preconfigured CG config (e.g., ID), the WTRU may transmit an indication (e.g., in SR, UCI, MAC 328 CE) for requesting to activate the selected CG config to network. The WTRU may transmit the QoE measurements using the activated CG config (e.g., in DCI, MAC 328 CE) and/or another CG config provided by the network.

The WTRU may determine whether/when to send the QoE measurement report based on QoE measurement events. For example, the WTRU may determine to skip and/or deprioritize/postpone sending QoE measurements if the buffer depletion rate remains within the normal depletion range for a certain configured time duration.

A WTRU may transmit an indication/report upon the arrival of XR data units intended for UL transmissions. The WTRU may trigger and/or transmit an indication to network for indicating the arrival of one or more data units (e.g., PDUs, PDU sets, data bursts) intended for UL transmission. Such an indication may be transmitted by WTRU to request a resource configuration (e.g., DG and/or CG) for transmitting the data units in the UL. Also, or alternatively, such an indication may be used to report the arrival of the data units from application/higher layers to the network.

The information included in the indication/report transmitted by the WTRU on the data units (e.g., payload size of PDU set/data burst, PDU set/data burst arrival time, time duration the PDU set/data burst remains in buffer and remaining time with respect to PDSB/delay bound) is described herein. For example, the WTRU may transmit the indication to network on the arrival of the data units in any of the following signaling and/or messages: RRC signaling and/or messages (e.g., via SRB1, SRB2, SRB3, SRB4); control PDUs associated with the AS layers (e.g., SDAP 318 control PDU, PDCP control PDU); an UL MAC 328 CE (e.g., regular BSR, periodic BSR, padding BSR, enhanced BSR, pre-emptive BSR, elastic BSR, new MAC 328 CE); UCI (e.g., single bit SR, multi-bit SR, feedback, ACK/NACK, CSI report); and/or PUSCH data.

A WTRU may trigger the indication/report of the arrival of data units (e.g., PDUs, PDU sets, data bursts) to the network. The WTRU may trigger the indication/report of the arrival of data units based on one or more of: a priority; timing information/attributes; payload attributes; and/or a status (e.g., the status of a buffer, LCH, LCG, etc.).

As described herein, a WTRU may trigger an indication/report of the arrival of data units based on a priority (e.g., a relative priority and/or an absolute priority). The WTRU may transmit the indication if the priority (e.g., relative priority) of a data unit received by the WTRU is higher than and/or lower than the priority of any previously received data units and/or remaining in the LCHs/buffers. Also, or alternatively, the WTRU may transmit the indication if the priority (e.g., absolute priority) value of data unit received by the WTRU is higher than and/or lower than one or more configured priority threshold values.

As described herein, a WTRU may trigger an indication/report of the arrival of data units based on timing information/attributes (e.g., data unit delay bound, remaining delay, buffering delay, and/or time of arrival). The WTRU may transmit the indication if the delay bound associated with the one or more received data units (e.g., PSDB, PDB) is higher than and/or lower than one or more configured delay bound threshold values. The WTRU may transmit the indication if the remaining delay value (e.g., determined as a difference between the time of arrival of the data unit and the delay bound associated with the received data unit (e.g., PSDB, PDB)), is higher than and/or lower than one or more configured remaining delay threshold values.

The WTRU may transmit the indication if the buffering delay value (e.g., time duration the data unit resides in a buffer), is higher than and/or lower than one or more configured buffering delay threshold values. The WTRU may also, or alternatively, determine the buffering delay as the difference between the time the data unit is received at a first protocol layer entity (e.g., SDAP 318, PDCP, RLC, LCH, MAC 328) and the time the data units leaves the first protocol layer entity and/or other second set of one or more protocol layer entities. The WTRU may transmit the indication if the time of arrival of the one or more received data units is within a configured time window. Also, or alternatively, the WTRU may transmit the indication if the time of arrival of the one or more received data units is higher than and/or lower than one or more configured arrival time threshold values.

A WTRU may trigger an indication/report of the arrival of data units based on payload attributes (e.g., size). The WTRU may transmit the indication when the payload size of the data unit (e.g., determined in the units of bits/bytes and/or number of PDUs) is higher than and/or lower than one or more configured payload size threshold values.

A WTRU may trigger an indication/report of the arrival of data units based on a status (e.g., status of a buffer, LCH, LCG, etc.). The WTRU may transmit the indication if the buffer, LCH, and/or LCG to which the received data unit is mapped to is empty (e.g., comprises no data). The WTRU may transmit the indication if the buffer, LCH, and/or LCG to which the received data unit is mapped to includes some data units (e.g., PDUs, PDU sets, data bursts). Also, or alternatively, the WTRU may transmit the indication if the buffer, LCH, and/or LCG to which the received data unit is mapped to includes some data units whose payload size and/or quantity (e.g., number of data units) is higher than and/or lower than one or more configured payload size and/or max number of data units threshold values.

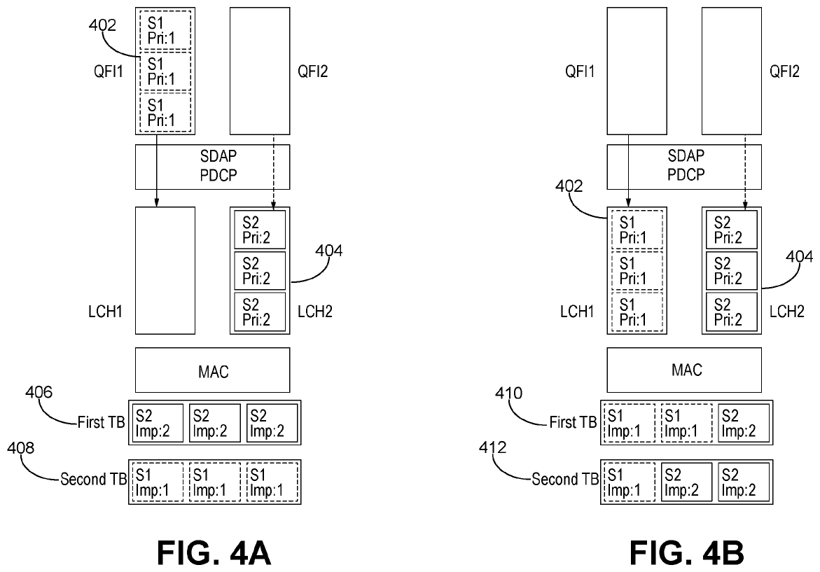

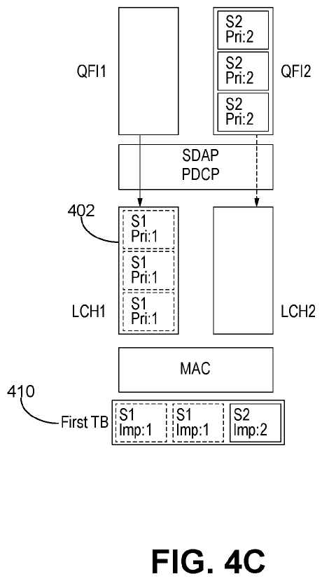

The WTRU may receive configuration information for triggering the indication on arrival of XR data units from the network. The configuration information for triggering the indication on arrival of XR data units may include one or more configurations and/or parameters associated with DRBs and/or LCHs for performing forwarding of XR data units (e.g., PDUs, PDU sets, data bursts) in UL/DL. Such parameters associated with LCHs may include at least the priority, PBR, and BSD. The configuration information for triggering the indication on arrival of XR data units may include one or more delay threshold values (e.g., difference between the time of arrival of a PDU set (e.g., time slot) and the PSDB associated with the PDU set). FIGS. 4A-4C illustrates an example associated with receiving and mapping PDU sets. As shown in FIGS. 4A-4C, a WTRU may receive PDU set 1 302 and 2 in QFI1 306 and QFI1 308, respectively, and the WTRU may map the received PDU sets to LCH1 332 and LCH2 334, respectively.

As shown in FIGS. 4A-4C, a WTRU may receive one or more data units (e.g., PDU set) from higher layers/application. The data units may be received at the SDAP and/or PDCP layer/entity. The WTRU may select a set (e.g., a set of one or more) LCHs for mapping the received data units (e.g., where the preconfigured priority values of the selected LCHs match and/or are associated with the priority of the data units). In such a scenario, the priority of the data units may be determined based on markings of priority/importance, which may be included in the header of the data units.

If any of the LCHs are empty (e.g., containing no data/data units in the buffers associated with the LCHs), the WTRU may transmit the indication/report to the network the information (e.g., payload size, timing info) on the arrival of the data units. Also, or alternatively, if the priority of a received data unit is higher than the priority of any remaining data units (e.g., including one or more PDUs associated with some data units received previously, mapped previously into any of the LCHs and/or remaining in the LCHs' buffers), the WTRU may transmit the indication/report to the network the information (e.g., payload size, timing info) on the arrival of the data units.

If the priority of the received data unit is less than and/or equal to the priority of any remaining data units received previously in any of the LCHs and if the difference between the time of arrival of the data unit (e.g., at WTRU and/or at LCH) and/or the PSDB of the PDU set is greater than and/or less than the delay threshold, the WTRU may transmit the indication/report to the network the information (e.g., payload size, timing info) on the arrival of the data units.

The WTRU may receive radio resources (e.g., DG) from the network, e.g., upon transmitting the indication. For example, the WTRU may transmit the received data units using the radio resources to the network.

As shown in FIG. 4A, the WTRU may transmit an indication (e.g., SR/BSR) to the network based on receiving PDU set 2 404. The WTRU may multiplex PDU set 2 404 to a first transport block (TB) 406.

The WTRU may multiplex PDU set 1 402 to a second TB 408 when transmitting in UL. PDU set 1 (e.g., high priority and/or Pri: 1) may arrive at t2. PDU set 2 (e.g., low priority and/or Pri: 2) may arrive at t1. PDU set 2 may be multiplexed to a first TB and PDU set 1 may be multiplexed in a second TB. Each PDU in PDU set 1 and each PDU in PDU set 2 may have an importance (e.g., Imp: 1 or Imp: 2). “Priority” may have a more specific data unit granularity than “importance.” “Importance” may be associated with a PDU set and may be configured/indicated/applied by the application layer. Whereas ‘priority’ may be associated with a PDU and may be configured/indicated/applied by the access stratum layers. In some examples, importance and priority may be the same and/or used interchangeably.

As shown in FIG. 4B, the WTRU may transmit an indication (e.g., SR/BSR) to the network based on receiving PDU set 1 402 and 2. The WTRU may multiplex the PDUs in PDU set 1 402 and PDU set 2 404 into a first TB 410 and a second TB 412, respectively, per an LCP procedure. PDU set 1 (high priority) may arrive at t2. PDU set 2 (low priority) may arrive at t1. PDUs in PDU set 1 and PDU set 2 may be multiplexed into first TB and second TB per LCP procedure.

As illustrated in FIG. 4C, the WTRU may transmit an indication (e.g., SR/BSR) based on receiving PDU set 1 302. The WTRU may multiplex PDU set 1 402 into first TB 410. As further shown in FIG. 4C, as LCH1 is non-empty, the arrival of PDU set 2 404 into LCH2 may not trigger an indication (e.g., SR/BSR) for a second TB. As shown in FIG. 4C, the WTRU may transmit an indication (e.g., SR/BSR) in certain scenarios. PDU set 1 (high priority) may arrive at t1. PDU set 2 (low priority) may arrive at t2. PDU set 1 may be multiplexed into first TB. While LCH1 may be non-empty, the arrival of PDU set 2 into LCH2 does not trigger BSR for a second TB.

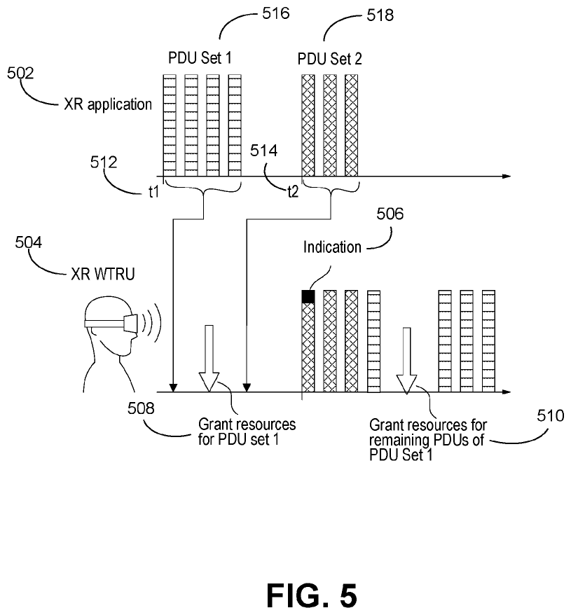

FIG. 5 illustrates transmissions of PDU sets according to embodiments. PDU set generation may take place at an XR application 502. The WTRU may be configured to receive configuration information comprising a threshold value. At t1 512, the XR application may transmit one or more generated PDUs in PDU set 1 516 to the XR WTRU. The XR application may also send grant (e.g., a dynamic grant and/or a configured grant) resources 508 for PDU set 1 to the XR WTRU. The XR WTRU may receive this first grant.

At t2 514, XR application may transmit one or more generated PDUs in PDU set 2 518 to the XR WTRU. The WTRU may determine to prioritize one or more protocol data units (PDUs) of a second PDU set over one or more PDUs of a first PDU set in a transmission to be sent in accordance with the first grant. The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value. Based on one or more conditions being met, the XR WTRU may transmit (e.g., to the network) one or more PDUs from PDU set 2 and an indication (e.g., in UCI) of the transmission using grant resources 508 designated for PDU set 1.

The WTRU may send the transmission comprising at least one of the one or more PDUs of the second PDU set in accordance with the first grant. The transmission may comprise information indicating that the second PDU set is prioritized over the first PDU set. The XR WTRU may also transmit (e.g., to the network) one or more PDUs of PDU set 1 using grant resources 508 designated for PDU set 1. The XR application may also send grant (e.g., a dynamic grant and/or a configured grant) resources 510 for PDU set 1 to the XR WTRU. The XR WTRU may transmit (e.g., to the network) any remaining PDUs of PDU set 1 using grant resources 510 allocated for PDU set 1.

Upon arrival of PDU Set 2 at the XR WTRU, the WTRU may determine whether any of the configured conditions (e.g., relative & absolute remaining time) are met. Remaining time may comprise PDU set 2 delay budget minus processing time. Processing time may comprise transmission time of the nth PDU minus the arrival time of the first PDU of a given PDU set.

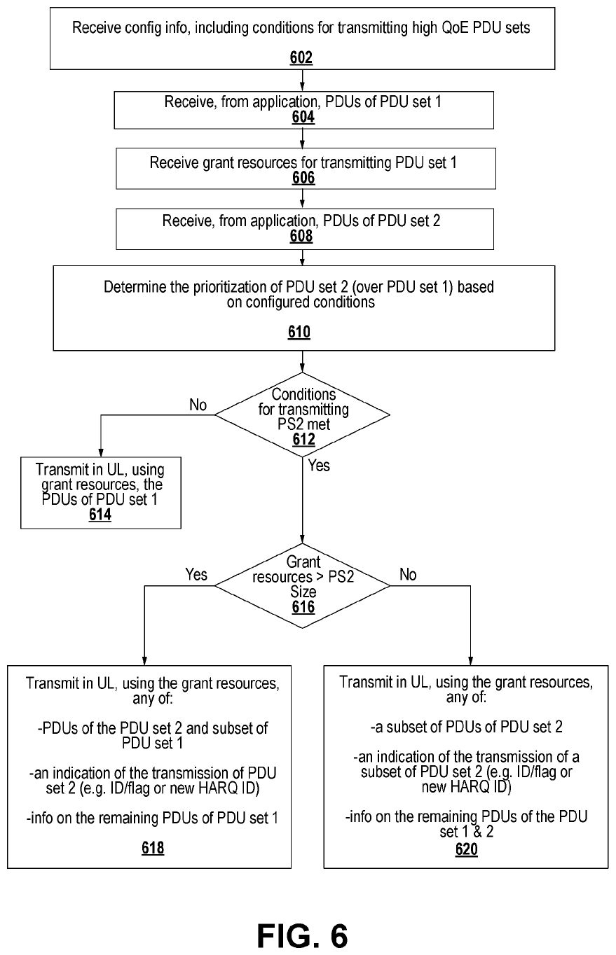

FIG. 6 illustrates a flowchart associated with receiving PDU sets according to several embodiments. At 602, the WTRU may receive configuration information, including conditions for transmitting high QoE PDU sets and/or one or more threshold values. The conditions may comprise relative remaining time of PDU sets (e.g., with reference to ongoing PDU sets) and/or absolute remaining time of PDU sets (e.g., with reference to threshold values).

At 604, the WTRU may receive (e.g., from the XR application) one or more PDUs of PDU set 1. At 606, the WTRU may receive (e.g., from the network) grant (e.g., dynamic grant and/or configured grant) resources for transmitting PDU set 1. At 608, the WTRU may receive (e.g., from the XR application) one or more PDUs of PDU set 2.

At 610, the WTRU may determine the prioritization of PDU set 2 (over PDU set 1) based on any of the following configured conditions: remaining time of PDU set 2 is then remaining time of PDU set 1 and/or remaining time of PDU set 2 is less than a threshold value. The WTRU may determine to prioritize one or more protocol data units (PDUs) of a second PDU set over one or more PDUs of a first PDU set in a transmission to be sent in accordance with the first grant. The WTRU may be configured to determine to prioritize the one or more PDUs of the second PDU set based on a remaining delay budget of the second PDU set being less than a remaining delay budget of the first PDU set or based on the remaining delay budget of the second PDU set being less than the threshold value.

At 612, the WTRU may determine if conditions for transmitting one or more PDUs of PDU set 2 are met. At 614, if the conditions are not met, the WTRU may transmit in UL (e.g., using dynamic grant and/or configured grant resources) one or more PDUs of PDU set 1.

At 616, if the conditions are met, the WTRU may determine if the grant (e.g., dynamic grant and/or configured grant) resources are greater than the PDU set 2 size. The WTRU may send the transmission comprising at least one of the one or more PDUs of the second PDU set in accordance with the first grant. The transmission may comprise information indicating that the second PDU set is prioritized over the first PDU set.

At 618, if the grant (e.g., dynamic grant and/or configured grant) resources are greater than (in some cases equal to) the PDU set 2 size, the WTRU may transmit in UL (e.g., using dynamic grant and/or configured grant resources) any of the following: PDUs of the PDU set 2 and subset of PDU set 1, and/or an indication of the transmission of PDU set 2 (e.g., ID/flag and/or new HARQ ID), and/or information on the remaining PDUs of PDU set 1.

At 620, if the grant (e.g., dynamic grant and/or configured grant) resources are less than (in some cases equal to) the PDU set 2 size the WTRU may transmit in UL (e.g., using dynamic grant and/or configured grant resources) any of the following: a subset of PDUs of PDU set 2, and/or an indication of the transmission of a subset of PDU set 2 (e.g., ID/flag or new HARQ ID), and/or information on the remaining PDUs of the PDU set 1 and PDU set 2.

A wireless transmit receive unit (WTRU) may be configured to receive configuration information comprising an indication of a first control channel monitoring configuration, a second control channel monitoring configuration, and a threshold value. The WTRU may monitor for control channel transmissions in accordance with the first control channel monitoring configuration. The WTRU may receive a first set of one or more protocol data unit (PDUs) based on a first control channel transmission received in accordance with the first control channel monitoring configuration. The WTRU may determine that at least one PDU of the first set of one or more PDUs remained in an application buffer for a period of time that is greater than the threshold value, or a remaining delay budget associated with the first set of one or more PDUs is less than a threshold. The WTRU may monitor for control channel transmissions in accordance with the second control channel monitoring configuration based on determining that the at least one PDU of the first set of one or more PDUs remained in the application buffer for the period of time that is greater than the threshold value, or the remaining delay budget associated with the first set of one or more PDUs is less than the threshold. The WTRU may transmit an indication that the WTRU has switched to the second control channel monitoring pattern.

The first control channel monitoring configuration may comprise a first search space and the second control channel monitoring configuration may comprise a second search space. The WTRU may receive a second set of one or more PDUs based on a second control channel transmission received in accordance with the second control channel monitoring configuration. The second set of one or more PDUs may be associated with the first set of one or more PDUs. The association may be determined based on a common identifier (e.g., in a PDU header). The WTRU may decrease a periodicity of monitoring based on the at least one PDU of the first set of one or more PDUs remaining in the application buffer for the period of time that is greater than the threshold value. The WTRU may receive the first set of one or more PDUs in a transmission.

The WTRU may update, based on the threshold value, a periodicity of monitoring and a reporting of an application buffer depletion rate, wherein the application buffer depletion rate is associated with an amount of PDUs of the first set of one or more PDUs remaining in the application buffer and a period of time that the PDUs of the first set of one or more PDUs has remained in the application buffer.

The WTRU may transmit the indication when updating a reporting periodicity. The WTRU may report, in a separate transmission, one or more statistics regarding the period of time that the at least one PDU of the first set of one or more PDUs remained in the application buffer.

1. A wireless transmit receive unit (WTRU) comprising:
a processor configured to:
receive configuration information comprising a threshold value;
receive a first grant;
determine to prioritize one or more protocol data units (PDUs) of a second PDU set over one or more PDUs of a first PDU set in a transmission to be sent in accordance with the first grant, wherein the WTRU is configured to determine to prioritize the one or more PDUs of the second PDU set based on a remaining delay budget of the second PDU set being less than a remaining delay budget of the first PDU set or based on the remaining delay budget of the second PDU set being less than the threshold value; and
send the transmission comprising at least one of the one or more PDUs of the second PDU set in accordance with the first grant, wherein the transmission comprises information indicating that the second PDU set is prioritized over the first PDU set.

2. The WTRU of claim 1, wherein the first grant is a first dynamic grant or a first configured grant.

3. The WTRU of claim 1, wherein the information indicating that the second PDU set is prioritized over the first PDU set is transmitted in an Uplink Control Information (UCI) indication, the UCI indication comprising information indicating remaining PDUs of the first PDU set and a remaining time associated with the first PDU set and information indicating remaining PDUs of the second PDU set and a remaining time associated with the second PDU set.

4. The WTRU of claim 1, wherein the information indicating that the second PDU set is prioritized over the first PDU set is transmitted in a scheduling request (SR), a buffer status report (BSR), or a delay status report (DSR).

5. The WTRU of claim 1, wherein the processor is configured to receive a second grant.

6. The WTRU of claim 1, wherein the one or more PDUs of the first PDU set are received prior to the one or more PDUs of the second PDU set being received from the application layer.

7. The WTRU of claim 1, wherein resources used for the transmission indicated by the first grant are sufficient for including each of the one or more PDUs of the second PDU set, wherein the transmission comprises at least one PDU of the one or more PDUs of the first PDU set, wherein the information indicating that the second PDU set is prioritized over the first PDU set comprises an indication regarding at least one PDU of the first PDU set that was not included in the transmission.

8. The WTRU of claim 1, wherein resources used for the transmission indicated by the first grant are insufficient for including each of the one or more PDUs of the second PDU set, wherein the indication that the second PDU set is prioritized over the first PDU set comprises an indication regarding at least one PDU of the second PDU set that was not included in the transmission.

9. The WTRU of claim 1, wherein either the one or more PDUs of the first PDU set are mapped to a first logical channel (LCH) and the one or more PDUs of the second PDU set are mapped to a second LCH, or the one or more PDUs of the first PDU set and the one or more PDUs of the second PDU set are mapped to the first LCH.

10. The WTRU of claim 1, wherein the first PDU set is associated with a first priority and a first payload size, and wherein the second PDU set is associated with a second priority and a second payload size, and the indication comprises the first payload size or the second payload size.

11. A method implemented by a wireless transmit receive unit (WTRU), the method comprising:
receiving configuration information comprising a threshold value;
receiving a first grant;
determining to prioritize one or more protocol data units (PDUs) of a second PDU set over one or more PDUs of a first PDU set in a transmission to be sent in accordance with the first grant, wherein the determining to prioritize the one or more PDUs of the second PDU set is based on a remaining delay budget of the second PDU set being less than a remaining delay budget of the first PDU set or based on the remaining delay budget of the second PDU set being less than the threshold value; and
sending the transmission comprising at least one of the one or more PDUs of the second PDU set in accordance with the first grant, wherein the transmission comprises information indicating that the second PDU set is prioritized over the first PDU set.

12. The method of claim 11, wherein the first grant is a first dynamic grant or a first configured grant.

13. The method of claim 11, wherein the information indicating that the second PDU set is prioritized over the first PDU set is transmitted in an Uplink Control Information (UCI) indication, the UCI indication comprising information indicating remaining PDUs of the first PDU set and a remaining time associated with the first PDU set and information indicating remaining PDUs of the second PDU set and a remaining time associated with the second PDU set.

14. The method of claim 11, wherein the information indicating that the second PDU set is prioritized over the first PDU set is transmitted in a scheduling request (SR), a buffer status report (BSR), or a delay status report (DSR).

15. The method of claim 11, further comprising receiving a second grant.

16. The method of claim 11, wherein the one or more PDUs of the first PDU set are received prior to the one or more PDUs of the second PDU set being received from the application layer.

17. The method of claim 11, wherein resources used for the transmission indicated by the first grant are sufficient for including each of the one or more PDUs of the second PDU set, wherein the transmission comprises at least one PDU of the one or more PDUs of the first PDU set, wherein the information indicating that the second PDU set is prioritized over the first PDU set comprises an indication regarding at least one PDU of the first PDU set that was not included in the transmission.

18. The method of claim 11, wherein resources used for the transmission indicated by the first grant are insufficient for including each of the one or more PDUs of the second PDU set, wherein the indication that the second PDU set is prioritized over the first PDU set comprises an indication regarding at least one PDU of the second PDU set that was not included in the transmission.

19. The method of claim 11, wherein either the one or more PDUs of the first PDU set are mapped to a first logical channel (LCH) and the one or more PDUs of the second PDU set are mapped to a second LCH, or the one or more PDUs of the first PDU set and the one or more PDUs of the second PDU set are mapped to the first LCH.

20. The method of claim 11, wherein the first PDU set is associated with a first priority and a first payload size, and the second PDU set is associated with a second priority and a second payload size, and the indication comprises the first payload size or the second payload size.
